(19) United States
(12) Patent Application Publication
(10) Pub. No.: US 2026/0019195 A1
(43) Pub. Date: Jan. 15, 2026

(54) TWO-PART HYBRID AUTOMATIC REPEAT/REQUEST-ACKNOWLEDGEMENT IN MULTI-CELL GROUPS

(71) Applicant: QUALCOMM Incorporated, San Diego, CA (US)

(72) Inventors: Mostafa KHOSHNEVISAN, San Diego, CA (US); Gokul SRIDHARAN, Sunnyvale, CA (US); Kianoush HOSSEINI, San Diego, CA (US)

(21) Appl. No.: 18/771,747

(22) Filed: Jul. 12, 2024

(51) Int. Cl. H04L 1/1812; H04L 5/00; H04W 8/22

(52) U.S. Cl. CPC H04L 1/1812; H04L 5/0053; H04W 8/22

(57) ABSTRACT

Methods, systems, and devices for wireless communications are described. A user equipment (UE) may receive signaling indicating a configuration for communications via a first cell group and a second cell group, the first cell group comprising a first cell associated with transmission of HARQ-ACK feedback associated with the first cell group and the second cell group comprising a second cell associated with transmission of HARQ-ACK feedback associated with the second cell group. The UE may transmit first information indicative of the HARQ-ACK feedback associated with the second cell group to the second cell, the first information comprising a first payload size smaller than a full HARQ-ACK feedback payload size associated with the second cell group. The UE may transmit second information indicative of the HARQ-ACK feedback associated with the second cell group to the first cell, the second information comprising a format that is based on the first information.

### FIELD OF TECHNOLOGY

The following relates to wireless communications, including two-part hybrid automatic repeat/request-acknowledgement in multi-cell groups.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving signaling indicating a configuration for communications via a first cell group and a second cell group, the first cell group including a first cell associated with transmission of hybrid automatic repeat/request-acknowledgement (HARQ-ACK) feedback associated with the first cell group and the second cell group including a second cell associated with transmission of HARQ-ACK feedback associated with the second cell group, transmitting first information indicative of the HARQ-ACK feedback associated with the second cell group to the second cell, where the first information includes a first payload size that is smaller than a second payload size of the HARQ-ACK feedback associated with the second cell group, and transmitting second information indicative of the HARQ-ACK feedback associated with the second cell group to the first cell, where the second information includes a format that is in accordance with the first information.

A UE for wireless communications is described. The UE may include one or more memories storing processor executable code, and one or more processors coupled with the one or more memories. The one or more processors may individually or collectively be operable to execute the code to cause the UE to receive signaling indicating a configuration for communications via a first cell group and a second cell group, the first cell group including a first cell associated with transmission of HARQ-ACK feedback associated with the first cell group and the second cell group including a second cell associated with transmission of HARQ-ACK feedback associated with the second cell group, transmit first information indicative of the HARQ-ACK feedback associated with the second cell group to the second cell, where the first information includes a first payload size that is smaller than a second payload size of the HARQ-ACK feedback associated with the second cell group, and transmit second information indicative of the HARQ-ACK feedback associated with the second cell group to the first cell, where the second information includes a format that is in accordance with the first information.

Another UE for wireless communications is described. The UE may include means for receiving signaling indicating a configuration for communications via a first cell group and a second cell group, the first cell group including a first cell associated with transmission of HARQ-ACK feedback associated with the first cell group and the second cell group including a second cell associated with transmission of HARQ-ACK feedback associated with the second cell group, means for transmitting first information indicative of the HARQ-ACK feedback associated with the second cell group to the second cell, where the first information includes a first payload size that is smaller than a second payload size of the HARQ-ACK feedback associated with the second cell group, and means for transmitting second information indicative of the HARQ-ACK feedback associated with the second cell group to the first cell, where the second information includes a format that is in accordance with the first information.

A non-transitory computer-readable medium storing code for wireless communications is described. The code may include instructions executable by one or more processors to receive signaling indicating a configuration for communications via a first cell group and a second cell group, the first cell group including a first cell associated with transmission of HARQ-ACK feedback associated with the first cell group and the second cell group including a second cell associated with transmission of HARQ-ACK feedback associated with the second cell group, transmit first information indicative of the HARQ-ACK feedback associated with the second cell group to the second cell, where the first information includes a first payload size that is smaller than a second payload size of the HARQ-ACK feedback associated with the second cell group, and transmit second information indicative of the HARQ-ACK feedback associated with the second cell group to the first cell, where the second information includes a format that is in accordance with the first information.

In some examples of the method, user equipment (UEs), and non-transitory computer-readable medium described herein, the first information includes bundled information in accordance with a logical operation applied to a set of bits in the HARQ-ACK feedback associated with the second cell group.

In some examples of the method, user equipment (UEs), and non-transitory computer-readable medium described herein, the bundled information includes a single bit indicating whether each bit in the set of bits may be associated with an acknowledgement (ACK) indication.

In some examples of the method, user equipment (UEs), and non-transitory computer-readable medium described herein, the first information includes bundled information in accordance with a logical operation applied to a set of bits in each block of a set of blocks in the HARQ-ACK feedback associated with the second cell group.

In some examples of the method, user equipment (UEs), and non-transitory computer-readable medium described herein, the bundled information includes a single bit for each block in the set of blocks indicating whether each bit in the set of bits for that block may be associated with an ACK indication.

In some examples of the method, user equipment (UEs), and non-transitory computer-readable medium described herein, the first information includes an indication of at least one of the HARQ-ACK feedback when the HARQ-ACK feedback may be in a first bit value set or an indication that the HARQ-ACK feedback may be not in the first bit value set.

In some examples of the method, user equipment (UEs), and non-transitory computer-readable medium described herein, the first bit value set corresponds to a set of outcomes for the HARQ-ACK feedback that satisfies a likelihood threshold.

In some examples of the method, user equipment (UEs), and non-transitory computer-readable medium described herein, the first bit value set corresponds to HARQ-ACK feedback including a threshold number of negative-acknowledgement (NACK) indications.

In some examples of the method, user equipment (UEs), and non-transitory computer-readable medium described herein, the first information includes an indication of at least one of, for each block in a set of blocks in the HARQ-ACK feedback associated with the second cell group, the HARQ-ACK feedback when the HARQ-ACK feedback for the block may be in a first bit value set or an indication that the HARQ-ACK feedback for the block may be not in the first bit value set.

In some examples of the method, user equipment (UEs), and non-transitory computer-readable medium described herein, the first bit value set for each block in the set of blocks corresponds to a set of outcomes for the HARQ-ACK feedback that satisfies a likelihood threshold.

In some examples of the method, user equipment (UEs), and non-transitory computer-readable medium described herein, the first bit value set corresponds to, for each block in the set of blocks, HARQ-ACK feedback for the block including a threshold number of NACK indications.

In some examples of the method, user equipment (UEs), and non-transitory computer-readable medium described herein, the first information includes a first set of one or more bits that identify a group index for a set of groups.

In some examples of the method, user equipment (UEs), and non-transitory computer-readable medium described herein, the first set of one or more bits include a fixed quantity of bits and each bit combination in the first set of one or more bits corresponds to a different group in the set of groups.

In some examples of the method, user equipment (UEs), and non-transitory computer-readable medium described herein, the second information includes a second set of one or more bits that identify a group member of a group in the set of groups in accordance with the group index.

In some examples of the method, user equipment (UEs), and non-transitory computer-readable medium described herein, the second set of one or more bits include a variable quantity of bits and a bit size of a bit combination in the second set of one or more bits may be in accordance with a quantity of members in the group in accordance with the group index identified by the first information.

In some examples of the method, user equipment (UEs), and non-transitory computer-readable medium described herein, the second information includes the HARQ-ACK feedback associated with the second cell group.

In some examples of the method, user equipment (UEs), and non-transitory computer-readable medium described herein, the second information includes an indication of whether the first information indicates the HARQ-ACK feedback associated with the second cell group.

In some examples of the method, user equipment (UEs), and non-transitory computer-readable medium described herein, the second information includes an indication of whether the HARQ-ACK feedback may be in a first bit value set or may be in a second bit value set and, when the HARQ-ACK feedback may be in the second bit value set, the HARQ-ACK feedback.

In some examples of the method, user equipment (UEs), and non-transitory computer-readable medium described herein, the second bit value set includes either a full set of bit values excluded from the first bit value set or a subset of bit values excluded from the first bit value set.

Some examples of the method, user equipment (UEs), and non-transitory computer-readable medium described herein may further include operations, features, means, or instructions for receiving radio resource control (RRC) signaling that activates transmitting the first information to the second cell and transmitting the second information to the first cell.

Some examples of the method, user equipment (UEs), and non-transitory computer-readable medium described herein may further include operations, features, means, or instructions for transmitting UE capability signaling indicating support for transmitting the first information to the second cell and transmitting the second information to the first cell, where the configuration may be in accordance with the UE capability signaling.

A method for wireless communications by a first cell of a first cell group is described. The method may include outputting, to a UE, signaling indicating a configuration for communications via the first cell group and a second cell group, the first cell group including the first cell associated with transmission of HARQ-ACK feedback associated with the first cell group and the second cell group including a second cell associated with transmission of HARQ-ACK feedback associated with the second cell group and obtaining second information indicative of the HARQ-ACK feedback associated with the second cell group from the UE, where the second information includes a format that is in accordance with a first information that is output to the second cell of the second cell group, the first information including a first payload size that is smaller than a second payload size of the HARQ-ACK feedback associated with the second cell group.

A wireless device associated with a first cell of a first cell group for wireless communications is described. The first cell of a first cell group may include one or more memories storing processor executable code, and one or more processors coupled with the one or more memories. The one or more processors may individually or collectively be operable to execute the code to cause the first cell of a first cell group to output, to a UE, signaling indicating a configuration for communications via the first cell group and a second cell group, the first cell group including the first cell associated with transmission of HARQ-ACK feedback associated with the first cell group and the second cell group including a second cell associated with transmission of HARQ-ACK feedback associated with the second cell group and obtain second information indicative of the HARQ-ACK feedback associated with the second cell group from the UE, where the second information includes a format that is in accordance with a first information that is output to the second cell of the second cell group, the first information including a first payload size that is smaller than a second payload size of the HARQ-ACK feedback associated with the second cell group.

Another first cell of a first cell group for wireless communications is described. The first cell of a first cell group may include means for outputting, to a UE, signaling indicating a configuration for communications via the first cell group and a second cell group, the first cell group including the first cell associated with transmission of HARQ-ACK feedback associated with the first cell group and the second cell group including a second cell associated with transmission of HARQ-ACK feedback associated with the second cell group and means for obtaining second information indicative of the HARQ-ACK feedback associated with the second cell group from the UE, where the second information includes a format that is in accordance with a first information that is output to the second cell of the second cell group, the first information including a first payload size that is smaller than a second payload size of the HARQ-ACK feedback associated with the second cell group.

A non-transitory computer-readable medium storing code for wireless communications is described. The code may include instructions executable by one or more processors to output, to a UE, signaling indicating a configuration for communications via the first cell group and a second cell group, the first cell group including the first cell associated with transmission of HARQ-ACK feedback associated with the first cell group and the second cell group including a second cell associated with transmission of HARQ-ACK feedback associated with the second cell group and obtain second information indicative of the HARQ-ACK feedback associated with the second cell group from the UE, where the second information includes a format that is in accordance with a first information that is output to the second cell of the second cell group, the first information including a first payload size that is smaller than a second payload size of the HARQ-ACK feedback associated with the second cell group.

Some examples of the method, first cell of a first cell groups, and non-transitory computer-readable medium described herein may further include operations, features, means, or instructions for decoding the second information to identify at least a portion of the HARQ-ACK feedback associated with the second cell group and outputting the at least the portion of the HARQ-ACK feedback to the second cell of the second cell group.

Some examples of the method, first cell of a first cell groups, and non-transitory computer-readable medium described herein may further include operations, features, means, or instructions for obtaining at least a portion of the first information from the second cell in the second cell group, decoding the second information in accordance with the at least the portion of the first information to identify the HARQ-ACK feedback associated with the second cell group, and outputting the HARQ-ACK feedback to the second cell of the second cell group.

In some examples of the method, first cell of a first cell groups, and non-transitory computer-readable medium described herein, the first information includes bundled information in accordance with a logical operation applied to a set of bits in the HARQ-ACK feedback associated with the second cell group.

In some examples of the method, first cell of a first cell groups, and non-transitory computer-readable medium described herein, the bundled information includes a single bit indicating whether each bit in the set of bits may be associated with an ACK indication.

In some examples of the method, first cell of a first cell groups, and non-transitory computer-readable medium described herein, the first information includes bundled information in accordance with a logical operation applied to a set of bits in each block of a set of blocks in the HARQ-ACK feedback associated with the second cell group.

In some examples of the method, first cell of a first cell groups, and non-transitory computer-readable medium described herein, the bundled information includes a single bit for each block in the set of blocks indicating whether each bit in the set of bits for that block may be associated with an ACK indication.

In some examples of the method, first cell of a first cell groups, and non-transitory computer-readable medium described herein, the first information includes an indication of at least one of the HARQ-ACK feedback when the HARQ-ACK feedback may be in a first bit value set or an indication that the HARQ-ACK feedback may be not in the first bit value set.

In some examples of the method, first cell of a first cell groups, and non-transitory computer-readable medium described herein, the first bit value set corresponds to a set of outcomes for the HARQ-ACK feedback that satisfies a likelihood threshold.

In some examples of the method, first cell of a first cell groups, and non-transitory computer-readable medium described herein, the first bit value set corresponds to HARQ-ACK feedback including a threshold number of NACK indications.

In some examples of the method, first cell of a first cell groups, and non-transitory computer-readable medium described herein, the first information includes an indication of at least one of, for each block in a set of blocks in the HARQ-ACK feedback associated with the second cell group, the HARQ-ACK feedback when the HARQ-ACK feedback for the block may be in a first bit value set or an indication that the HARQ-ACK feedback for the block may be not in the first bit value set.

In some examples of the method, first cell of a first cell groups, and non-transitory computer-readable medium described herein, the first bit value set for each block in the set of blocks corresponds to a set of outcomes for the HARQ-ACK feedback that satisfies a likelihood threshold.

In some examples of the method, first cell of a first cell groups, and non-transitory computer-readable medium described herein, the first bit value set corresponds to, for each block in the set of blocks, HARQ-ACK feedback for the block including a threshold number of NACK indications.

In some examples of the method, first cell of a first cell groups, and non-transitory computer-readable medium described herein, the first information includes a first set of one or more bits that identify a group index for a set of groups.

In some examples of the method, first cell of a first cell groups, and non-transitory computer-readable medium described herein, the first set of one or more bits include a fixed quantity of bits and each bit combination in the first set of one or more bits corresponds to a different group in the set of groups.

In some examples of the method, first cell of a first cell groups, and non-transitory computer-readable medium described herein, the second information includes a second set of one or more bits that identify a group member of a group in the set of groups in accordance with the group index.

In some examples of the method, first cell of a first cell groups, and non-transitory computer-readable medium described herein, the second set of one or more bits include a variable quantity of bits and a bit size of a bit combination in the second set of one or more bits may be in accordance with a quantity of members in the group in accordance with the group index identified by the first information.

In some examples of the method, first cell of a first cell groups, and non-transitory computer-readable medium described herein, the second information includes the HARQ-ACK feedback associated with the second cell group.

In some examples of the method, first cell of a first cell groups, and non-transitory computer-readable medium described herein, the second information includes an indication of whether the first information indicates the HARQ-ACK feedback associated with the second cell group.

In some examples of the method, first cell of a first cell groups, and non-transitory computer-readable medium described herein, the second information includes an indication of whether the HARQ-ACK feedback may be in a first bit value set or may be in a second bit value set and, when the HARQ-ACK feedback may be in the second bit value set, the HARQ-ACK feedback.

In some examples of the method, first cell of a first cell groups, and non-transitory computer-readable medium described herein, the second bit value set includes either a full set of bit values excluded from the first bit value set or a subset of bit values excluded from the first bit value set.

Some examples of the method, first cell of a first cell groups, and non-transitory computer-readable medium described herein may further include operations, features, means, or instructions for outputting, to the UE, RRC signaling that activates the UE to transmit the first information to the second cell and to transmit the second information to the first cell.

Some examples of the method, first cell of a first cell groups, and non-transitory computer-readable medium described herein may further include operations, features, means, or instructions for obtaining, from the UE, UE capability signaling that indicates the UE supports transmitting the first information to the second cell and transmitting the second information to the first cell, where the configuration may be in accordance with the UE capability signaling.

A method for wireless communications by a second cell of a second cell group is described. The method may include obtaining signaling indicating a configuration for communications for a UE via a first cell group and the second cell group, the first cell group including a first cell associated with transmission of HARQ-ACK feedback associated with the first cell group and the second cell group including the second cell associated with transmission of HARQ-ACK feedback associated with the second cell group and obtaining first information indicative of the HARQ-ACK feedback associated with the second cell group from the UE, where the first information includes a first payload size that is smaller than a second payload size of the HARQ-ACK feedback associated with the second cell group and second information indicative of the HARQ-ACK feedback associated with the second cell group is output to the first cell, the second information including a format that is in accordance with the first information.

A wireless device associated with a second cell of a second cell group for wireless communications is described. The second cell of a second cell group may include one or more memories storing processor executable code, and one or more processors coupled with the one or more memories. The one or more processors may individually or collectively be operable to execute the code to cause the second cell of a second cell group to obtain signaling indicating a configuration for communications for a UE via a first cell group and the second cell group, the first cell group including a first cell associated with transmission of HARQ-ACK feedback associated with the first cell group and the second cell group including the second cell associated with transmission of HARQ-ACK feedback associated with the second cell group and obtain first information indicative of the HARQ-ACK feedback associated with the second cell group from the UE, where the first information includes a first payload size that is smaller than a second payload size of the HARQ-ACK feedback associated with the second cell group and second information indicative of the HARQ-ACK feedback associated with the second cell group is output to the first cell, the second information including a format that is in accordance with the first information.

Another second cell of a second cell group for wireless communications is described. The second cell of a second cell group may include means for obtaining signaling indicating a configuration for communications for a UE via a first cell group and the second cell group, the first cell group including a first cell associated with transmission of HARQ-ACK feedback associated with the first cell group and the second cell group including the second cell associated with transmission of HARQ-ACK feedback associated with the second cell group and means for obtaining first information indicative of the HARQ-ACK feedback associated with the second cell group from the UE, where the first information includes a first payload size that is smaller than a second payload size of the HARQ-ACK feedback associated with the second cell group and second information indicative of the HARQ-ACK feedback associated with the second cell group is output to the first cell, the second information including a format that is in accordance with the first information.

A non-transitory computer-readable medium storing code for wireless communications is described. The code may include instructions executable by one or more processors to obtain signaling indicating a configuration for communications for a UE via a first cell group and the second cell group, the first cell group including a first cell associated with transmission of HARQ-ACK feedback associated with the first cell group and the second cell group including the second cell associated with transmission of HARQ-ACK feedback associated with the second cell group and obtain first information indicative of the HARQ-ACK feedback associated with the second cell group from the UE, where the first information includes a first payload size that is smaller than a second payload size of the HARQ-ACK feedback associated with the second cell group and second information indicative of the HARQ-ACK feedback associated with the second cell group is output to the first cell, the second information including a format that is in accordance with the first information.

Some examples of the method, second cell of a second cell groups, and non-transitory computer-readable medium described herein may further include operations, features, means, or instructions for outputting at least a portion of the first information to the second cell of the second cell group, obtaining at least a portion of the second information from the second cell in the second cell group in accordance with the first information, and decoding the first information and the second information in accordance with the at least the portion of the second information to identify the HARQ-ACK feedback associated with the second cell group.

In some examples of the method, second cell of a second cell groups, and non-transitory computer-readable medium described herein, the first information includes bundled information in accordance with a logical operation applied to a set of bits in the HARQ-ACK feedback associated with the second cell group.

In some examples of the method, second cell of a second cell groups, and non-transitory computer-readable medium described herein, the bundled information includes a single bit indicating whether each bit in the set of bits may be associated with an ACK indication.

In some examples of the method, second cell of a second cell groups, and non-transitory computer-readable medium described herein, the first information includes bundled information in accordance with a logical operation applied to a set of bits in each block of a set of blocks in the HARQ-ACK feedback associated with the second cell group.

In some examples of the method, second cell of a second cell groups, and non-transitory computer-readable medium described herein, the bundled information includes a single bit for each block in the set of blocks indicating whether each bit in the set of bits for that block may be associated with an ACK indication.

In some examples of the method, second cell of a second cell groups, and non-transitory computer-readable medium described herein, the first information includes an indication of at least one of the HARQ-ACK feedback when the HARQ-ACK feedback may be in a first bit value set or an indication that the HARQ-ACK feedback may be not in the first bit value set.

In some examples of the method, second cell of a second cell groups, and non-transitory computer-readable medium described herein, the first bit value set corresponds to HARQ-ACK feedback including a threshold number of NACK indications.

In some examples of the method, second cell of a second cell groups, and non-transitory computer-readable medium described herein, the first bit value set corresponds to a set of outcomes for the HARQ-ACK feedback that satisfies a likelihood threshold.

In some examples of the method, second cell of a second cell groups, and non-transitory computer-readable medium described herein, the first information includes an indication of at least one of, for each block in a set of blocks in the HARQ-ACK feedback associated with the second cell group, the HARQ-ACK feedback when the HARQ-ACK feedback for the block may be in a first bit value set or an indication that the HARQ-ACK feedback for the block may be not in the first bit value set.

In some examples of the method, second cell of a second cell groups, and non-transitory computer-readable medium described herein, the first bit value set for each block in the set of blocks corresponds to a set of outcomes for the HARQ-ACK feedback that satisfies a likelihood threshold.

In some examples of the method, second cell of a second cell groups, and non-transitory computer-readable medium described herein, the first bit value set corresponds to, for each block in the set of blocks, HARQ-ACK feedback for the block including a threshold number of NACK indications.

In some examples of the method, second cell of a second cell groups, and non-transitory computer-readable medium described herein, the first information includes a first set of one or more bits that identify a group index for a set of groups.

In some examples of the method, second cell of a second cell groups, and non-transitory computer-readable medium described herein, the first set of one or more bits include a fixed quantity of bits and each bit combination in the first set of one or more bits corresponds to a different group in a set of groups.

In some examples of the method, second cell of a second cell groups, and non-transitory computer-readable medium described herein, the second information includes a second set of one or more bits that identify a group member of a group in the set of groups in accordance with the group index.

In some examples of the method, second cell of a second cell groups, and non-transitory computer-readable medium described herein, the second set of one or more bits include a variable quantity of bits and a bit size of a bit combination in the second set of one or more bits may be in accordance with a quantity of members in the group in accordance with the group index identified by the first information.

In some examples of the method, second cell of a second cell groups, and non-transitory computer-readable medium described herein, the second information includes the HARQ-ACK feedback associated with the second cell group.

In some examples of the method, second cell of a second cell groups, and non-transitory computer-readable medium described herein, the second information includes an indication of whether the first information indicates the HARQ-ACK feedback associated with the second cell group.

In some examples of the method, second cell of a second cell groups, and non-transitory computer-readable medium described herein, the second information includes an indication of whether the HARQ-ACK feedback may be in a first bit value set or may be in a second bit value set and, when the HARQ-ACK feedback may be in the second bit value set, the HARQ-ACK feedback.

In some examples of the method, second cell of a second cell groups, and non-transitory computer-readable medium described herein, the second bit value set includes either a full set of bit values excluded from the first bit value set or a subset of bit values excluded from the first bit value set.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports two-part hybrid automatic repeat/request-acknowledgement (HARQ-ACK) in multi-cell groups in accordance with one or more aspects of the present disclosure.

FIG. 2 shows an example of a wireless communications system that supports two-part HARQ-ACK in multi-cell groups in accordance with one or more aspects of the present disclosure.

FIGS. 3A and 3B show examples of a HARQ configuration that supports two-part HARQ-ACK in multi-cell groups in accordance with one or more aspects of the present disclosure.

FIG. 4 shows an example of a HARQ configuration that supports two-part HARQ-ACK in multi-cell groups in accordance with one or more aspects of the present disclosure.

FIG. 5 shows an example of a HARQ configuration that supports two-part HARQ-ACK in multi-cell groups in accordance with one or more aspects of the present disclosure.

FIG. 6 shows an example of a HARQ configuration that supports two-part HARQ-ACK in multi-cell groups in accordance with one or more aspects of the present disclosure.

FIGS. 7 and 8 show block diagrams of devices that support two-part HARQ-ACK in multi-cell groups in accordance with one or more aspects of the present disclosure.

FIG. 9 shows a block diagram of a communications manager that supports two-part HARQ-ACK in multi-cell groups in accordance with one or more aspects of the present disclosure.

FIG. 10 shows a diagram of a system including a device that supports two-part HARQ-ACK in multi-cell groups in accordance with one or more aspects of the present disclosure.

FIGS. 11 and 12 show block diagrams of devices that support two-part HARQ-ACK in multi-cell groups in accordance with one or more aspects of the present disclosure.

FIG. 13 shows a block diagram of a communications manager that supports two-part HARQ-ACK in multi-cell groups in accordance with one or more aspects of the present disclosure.

FIG. 14 shows a diagram of a system including a device that supports two-part HARQ-ACK in multi-cell groups in accordance with one or more aspects of the present disclosure.

FIGS. 15 through 19 show flowcharts illustrating methods that support two-part HARQ-ACK in multi-cell groups in accordance with one or more aspects of the present disclosure.

### DETAILED DESCRIPTION

Wireless networks may support carrier aggregation (CA) or dual-connectivity (DC) communication techniques where user equipment (UE) are configured with multiple cell groups. For example, the UE may be configured with a primary cell (PCell) of a master cell group (MCG) or a primary secondary cell (PSCell) of a secondary cell group (SCG) in a DC scenario. Each cell group may have at least one cell designated for receiving physical uplink control channel (PUCCH) transmissions from the UE, such as hybrid automatic repeat/request-acknowledgement (HARQ-ACK) feedback. The HARQ-ACK transmissions may be used for scheduling (re) transmissions between the UE and each cell group. However, in some cases the cells within the cell group(s) may not be collocated, which may introduce latency associated with backhaul communications between the cell groups. Accordingly, HARQ-ACK transmissions between non-collocated cell groups may fail to satisfy associated latency requirements and may disrupt HARQ operations with the UE.

Accordingly, aspects of the techniques described herein provide for a two-part HARQ-ACK feedback when the UE is configured with multiple cell groups. For example, a UE may receive or otherwise obtain signaling indicating a configuration for communications via the first cell group and the second cell group. The first cell group may include a first cell used for transmission of HARQ-ACK feedback associated with the first cell group. The second cell group may include a second cell used for transmission of HARQ-ACK feedback associated with the second cell group. The UE may transmit first information indicative of the HARQ-ACK feedback associated with the second cell group to the second cell. The first information may include a first payload size that is a smaller payload size relative to a second payload size of the HARQ-ACK feedback associated with the second cell group. The UE may transmit second information indicative of the HARQ-ACK feedback associated with the second cell group to the first cell. The second information may include a format that is in accordance with the first information.

Aspects of the disclosure are initially described in the context of wireless communications systems. Aspects of the disclosure are further illustrated by and described with reference to apparatus diagrams, system diagrams, and flowcharts that relate to two-part HARQ-ACK in multi-cell groups.

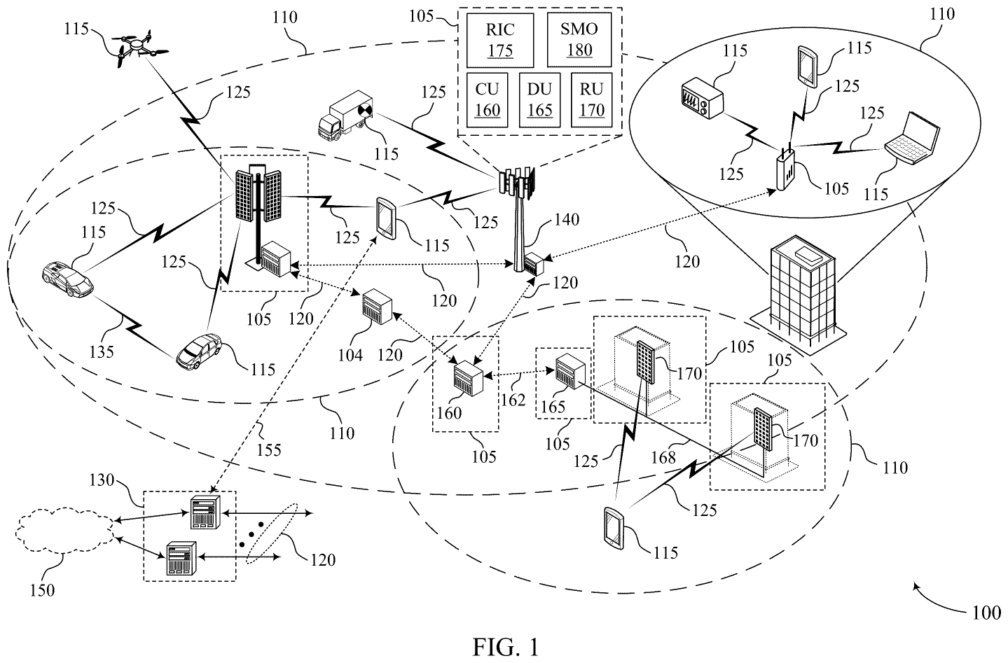

FIG. 1 shows an example of a wireless communications system 100 that supports two-part HARQ-ACK in multi-cell groups in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive signaling indicating a configuration for communications via a first cell group and a second cell group, the first cell group comprising a first cell associated with transmission of HARQ-ACK feedback associated with the first cell group and the second cell group comprising a second cell associated with transmission of HARQ-ACK feedback associated with the second cell group. The UE 115 may transmit first information indicative of the HARQ-ACK feedback associated with the second cell group to the second cell, wherein the first information comprises a first payload size that is smaller than a second payload size of the HARQ-ACK feedback associated with the second cell group. The UE 115 may transmit second information indicative of the HARQ-ACK feedback associated with the second cell group to the first cell, wherein the second information comprises a format that is in accordance with the first information.

A first cell (e.g., a wireless device associated with the first cell, such as a network entity 105) in a first cell group (e.g., a group of network entities 105) may output, to a UE 115, signaling indicating a configuration for communications via the first cell group and a second cell group, the first cell group comprising the first cell associated with transmission of HARQ-ACK feedback associated with the first cell group and the second cell group comprising a second cell associated with transmission of HARQ-ACK feedback associated with the second cell group. The first cell may obtain second information indicative of the HARQ-ACK feedback associated with the second cell group from the UE 115, wherein the second information comprises a format that is in accordance with a first information that is output to the second cell of the second cell group, the first information comprising a first payload size that is smaller than a second payload size of the HARQ-ACK feedback associated with the second cell group.

A second cell (e.g., a wireless device associated with the second cell, such as a network entity 105) in a second cell group (e.g., a group of network entities 105) may obtain signaling indicating a configuration for communications for a UE 115 via a first cell group and the second cell group, the first cell group comprising a first cell associated with transmission of HARQ-ACK feedback associated with the first cell group and the second cell group comprising the second cell associated with transmission of HARQ-ACK feedback associated with the second cell group. The second cell may obtain first information indicative of the HARQ-ACK feedback associated with the second cell group from the UE 115, wherein the first information comprises a first payload size that is smaller than a second payload size of the HARQ-ACK feedback associated with the second cell group and second information indicative of the HARQ-ACK feedback associated with the second cell group is output to the first cell, the second information comprising a format that is in accordance with the first information.

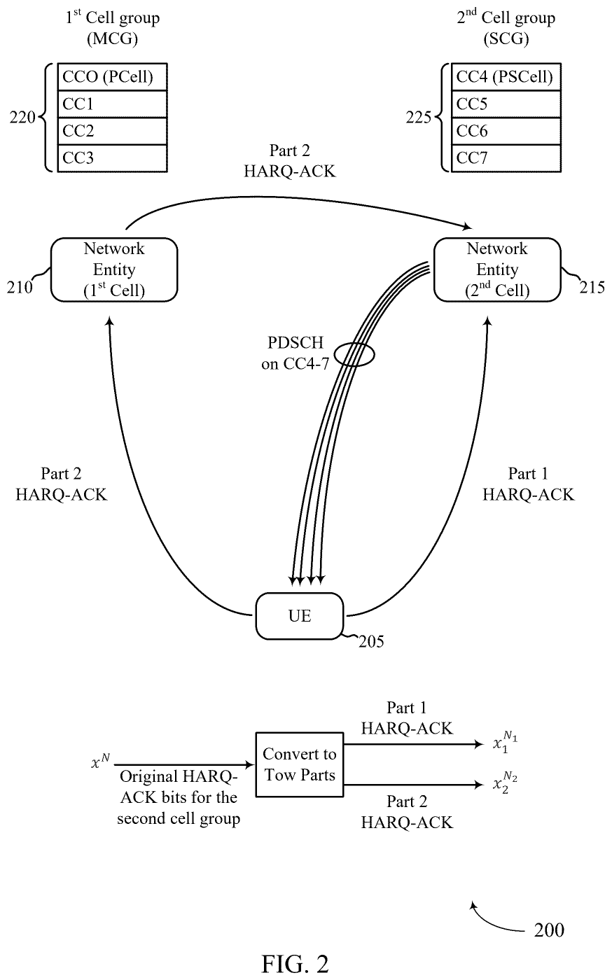

FIG. 2 shows an example of a wireless communications system 200 that supports two-part HARQ-ACK in multi-cell groups in accordance with one or more aspects of the present disclosure. Wireless communications system 200 may implement aspects of wireless communications system 100. Wireless communications system 200 may include a UE 205, a network entity 210, and a network entity 215, which may be examples of the corresponding devices described herein. For example, the network entity 210 may be an example of a first cell of a first cell group and the network entity 215 may be an example of a second cell of a second cell group.

The UE 205 may be configured to communicate via multiple cell groups. One example of multiple cell groups may include the UE 205 being configured to communicate via a DC configuration. The DC configuration may include the UE 205 being configured with an MCG and one or more SCGs. The MCG may have one or more cells and each SCG may have one or more cells. Another example of multiple cells may include the UE 205 being configured to communicate via a CA configuration. The CA configuration may include the UE 205 being configured with a first cell group and a second cell group. Each of the first cell group and the second cell group may include one or more cells. In some aspects, each cell in a cell group may also be associated with a CC used for communications between the UE and that cell. Accordingly, references to a cell and a CC may be used interchangeably.

In some aspects, the UE 205 configured for communications via multiple cells groups may include multiple PUCCH groups. For example, the UE 205 may be configured with two PUCCH groups in DC or CA configurations. For DC configurations, the PUCCH of all CCs in the MCG may be sent on the PCell and the PUCCH of all CCs in the SCG(s) are sent on the PSCell (e.g., the PCell of the SCG). For CA configurations, in some cases the PUCCH of all cells within a cell group is sent on the PSCell or PUCCH cell of that cell group (e.g., one PUCCH group). In other CA cases, two PUCCH groups may be configured for the UE 205, which may be based on the capability of the UE 205. For example, the UE 205 configured for CA communications may be configured with a primary PUCCH group including a PCell and one or more SCells (e.g., similar to the MCG in DC configurations) as well as a secondary PUCCH group that includes a PUCCH SCell as well as one or more SCells (e.g., similar to the SCG in DC configurations).

The PUCCH cell for a cell group is generally configured as part of the PDSCH-ServingCellConfig parameter. For example, the UE 205 may use this parameter to identify or otherwise determine the serving cell index for the PUCCH cell that carries PUCCH for this serving cell. That is, the PDSCH-ServingCellConfig parameter may carry or otherwise convey information that identifies the pucch-Cell ServCellIndex used by the UE 205 to determine the serving cell index (e.g., to identify the PUCCH cell for that cell group).

In some aspects, the uplink coverage area associated with multi-cell group configurations for the UE 205 may differ. For example, when the CA deployment is feasible, the cell groups may include collocated cells within a single or coordinated DU (e.g., intra-frequency CA) deployment or, otherwise, a non-collocated cell deployment may be used with a low latency backhaul interface between the cells. In such cases, multiplexing uplink control information for all carriers (cells or CCs) may be dynamically performed on the anchor cell (e.g., PCell or PUCCH cell). Reducing the downlink/uplink imbalance may rely on a low-band coverage layer for the uplink given that all uplink control information may be carried on a cell (CC) in a lower band with more favorable propagation techniques.

When meeting the deployment requirements for CA (with single PUCCH group) is not feasible, some wireless networks may choose a DC configuration (or multiple PUCCH groups with CA) instead. For example, this is the case for all existing deployments for FR1 and FR2 that require such aggregation for the UE 205. With DC (or multiple PUCCH groups in CA), the downlink coverage of each cell group may be limited by its own uplink coverage (e.g., as the uplink control is sent on a CC in the same cell group). High throughput of high-band spectrum cell deployments may be realized in favorable coverage regions. Accordingly, this may result in a need to enhance the uplink coverage in non-collocated deployment scenarios.

Accordingly, in some cases uplink coverage enhancement for CA or DC configurations may be needed (e.g., how to provide a low-band anchor in non-collocated/non-coordinated multi-carrier systems). This may include the uplink feedback (e.g., HARQ information bits, RLC status PDU, and the like) for the high-band cell group to be sent on the low-band CC with better or extended coverage. For example, the HARQ bits can be sent as a group ACK/NACK and protected with CRC. Semi-statically reserving some resources for the high-band cell group on a low-band anchor cell (e.g., the PCell of the MCG in DC) may be used. However, the backhaul latency may be dependent on the deployment and the interface used (e.g., may be commonly assumed to be around 10-20 ms). For such relatively large backhaul latency, increasing the number of HARQ processes to fill the scheduling gaps may not always be feasible (e.g., in high frequency bands with large SCS). For example, this may also impact buffering and HARQ management by the UE 205.

Accordingly, in some situations the UE 205 may be configured with a first cell group that the UE 205 communicates with on a low-band DU/RU. This may be considered the MCG in a DC configuration or the first PUCCH group in a CA configuration with two PUCCH groups. The PUCCH cell for this first cell group is the PCell (e.g., a first cell in the first cell group, in this example) that carries the uplink control (e.g., UCI) on PUCCH for all downlink CCs in this first cell group.

The UE 205 may also be configured with a second cell group that the UE 205 communicates with on a high-band DR/RU. This may be considered the SCG in a DC configuration or a second PUCCH group in a CA configuration with two PUCCH groups. The PUCCH cell (e.g., a second cell in this second cell group) for this second cell group is the PSCell (e.g., in case of DC) or PUCCH SCell (e.g., in case of CA with two PUCCH cell groups), which carries the uplink control (e.g., UCI) on PUCCH for all downlink CCs in this second cell group. The uplink coverage for this PUCCH cell (e.g., the high-band cell, or second cell of the second cell group) may be limited.

To enhance the uplink coverage in this scenario, some wireless networks may use different approaches. One approach may include the UCIs that are not delay sensitive (e.g., CSI) being sent on the PCell of the first cell group to free up resources on the second PUCCH cell in the second cell group such that delay sensitive UCIs (e.g., HARQ-ACK feedback) can be sent directly to the high-band DU/RU. Another approach is for the full HARQ-ACK feedback (e.g., HARQ-ACK codebook repetition) to be sent to both PUCCH cells (in both cell groups) to achieve low latency opportunistically on the second cell group with a backup on the first cell group in case the HARQ-ACK sent on the second cell group is not decoded. Another approach is for the full HARQ-ACK feedback to be sent to the second cell for HARQ operations and a compressed version of the HARQ-ACK feedback to be sent to the first cell to support link adaptation in the second cell group.

However, aspects of the techniques described herein provide a different method to send the HARQ-ACK feedback in two parts. Part one (e.g., first information indicative of the HARQ-ACK feedback associated with the second cell group) of the HARQ-ACK feedback may be sent to the second cell in the second cell group. In some examples, the part one of the HARQ-ACK feedback may indicate the HARQ-ACK payload for all or some of the HARQ process identifiers for the likely payloads or outcomes so that those HARQ process identifiers can be reused immediately by the second cell group. In some aspects, the size of the part one HARQ-ACK feedback may be substantially smaller than the original HARQ-ACK payload so that it can be communicated successfully in the second cell group (e.g., which may be uplink coverage limited). Indicating the most likely payloads or outcomes may increase the likelihood that those HARQ process identifiers are immediately reused (e.g., after the second cell decodes part one of the HARQ-ACK feedback).

Part two (e.g., second information indicative of the HARQ-ACK feedback associated with the second cell group) of the HARQ-ACK feedback may be sent to the first cell in the first cell group. In some aspects, the part two of the HARQ-ACK feedback may be used for the case that the second cell group cannot immediately reuse the HARQ process identifiers (e.g., based on decoding the part one of the HARQ-ACK feedback). The first cell may forward the part two information to the second cell via a backhaul interface. In some aspects, the first cell in the first cell group may not have the uplink coverage issues present in the second cell group. Accordingly, in some aspects the part two HARQ-ACK feedback associated with the second cell group that is sent to the first cell may have a larger payload (e.g., may be the full HARQ-ACK feedback payload or codebook). In some aspects, the part two of the HARQ-ACK feedback associated with the second cell group may carry or otherwise convey complimentary information not indicated in part one of the HARQ-ACK feedback. Thus, with some delay due to the backhaul interface, the second cell may be able to reuse the HARQ process identifiers in this case as well.

In some non-limiting examples, the HARQ-ACK codebook includes N bits where the 2^{N} codepoints may not be equally likely. This may be due to the downlink (PDSCH) BLER target being <=10% or due to correlation in the time/frequency/layers (e.g., across slots, code block groups, CCs, TBs). Thus, compression may be possible to minimize the average HARQ-ACK payload. This may be a source coding problem with optimal loss-less compression (e.g., entropy). The two-part HARQ-ACK feedback may provide a mechanism to achieve this compression in practice. The two parts may be separately encoded. The network may decode the first part before decoding the second part. In some examples, the first part has a fixed size and the size and interpretation of the second part may depend on the indicated codepoint of the first part. The two-part HARQ-ACK feedback may be very close to the optimal compression in terms of average length.

For example, the UE 205 may transmit the HARQ-ACK payload in two parts (e.g., part one and part two) that are separately encoded. For example, for an original HARQ-ACK codebook with N bits, part one has N₁ bits and part two has N₂ bits. In some examples, N₁ is fixed (e.g., not a function of x^{N}, meaning that part one has a fixed size for a given N). In some examples, N2 may be variable in length and may be a function of

$${x}_{1}^{{N}_{1}} ,$$

meaning that part two has a variable length depending on part one. The network first decodes the first part (e.g., part one) and then determines the length of second part (e.g., part two). The network then decodes part two and determines the original HARQ-ACK codebook. As one non-limiting example, a four-bit HARQ-ACK codebook with a 10% BLER may include the part one using one bit (e.g., “1” or “0”) and part two using zero or four bits. If all four bits are ACK, the part one may indicate a “1” and the part two may be empty (e.g., zero bits). Otherwise, the part one may indicate a “0” and the part two may indicate the full four bits. There is a probability of 0.6561 that all four bits will be ACK resulting in one bit being transmitted, and there is a probability of 0.3439 that there will be at least one NACK indication resulting in five bits being transmitted. This results in an average of 2.3756 bits being transmitted for a four-bit HARQ-ACK codebook, thus providing increased efficiency and reduced overhead.

Thus, the UE 205 may receive or otherwise obtain (and the network entity 210 may transmit or otherwise output) signaling indicating a configuration for communications via a first cell group and a second cell group. The signaling may include RRC signaling or other signaling between the UE 205 and the network entity 210. The configuration for multi-cell group communications may include configuring the UE 205 for communications according to a DC scenario or a CA scenario. For example, the first cell group may be an MCG in a DC deployment scenario or may be a primary/first PUCCH group in a CA scenario with two PUCCH cell groups. The first cell group may include a first cell that may be the PCell for this cell group (e.g., carries uplink control on PUCCH for all downlink CCs in this cell group). For example, the first cell may be used for transmission (e.g., by the UE 205) of HARQ-ACK feedback associated with the first cell group. The network entity 210 may be an example of the first cell in the first cell group in this example. For example, the first cell group may include one or more cells or CCs, such as a CC group 220 that includes CC0, CC1, CC2, and CC3, which may collectively be referred to as CC0-3.

The second cell group may be a SCG in the DC scenario or a second PUCCH group in the CA scenario with two PUCCH groups. The second cell group may include a second cell that may be the PSCell for the DC scenario or the PUCCH SCell in the CA scenario with two PUCCH groups (e.g., carries uplink control on PUCCH for all downlink CCs in this cell group). For example, the second cell may be used for transmission of HARQ-ACK feedback associated with the second cell group. The network entity 215 may be an example of the second cell in the second cell group in this example. For example, the second cell group may include one or more cells or CCs, such as a CC group 225 that includes CC4, CC5, CC6, and CC7, which may collectively be referred to as CC4-7.

The UE 205 may transmit or otherwise output first information indicative of the HARQ-ACK feedback associated with the second cell group to the second cell (e.g., to the network entity 215). The first information may have a first payload size that is smaller than a second payload size of the HARQ-ACK feedback associated with the second cell group. The first information indicative of the HARQ-ACK feedback associated with the second cell group may correspond to the first part or part one of the HARQ-ACK feedback associated with the second cell group.

The UE 205 may transmit or otherwise output second information indicative of the HARQ-ACK feedback associated with the second cell group to the first cell (e.g., to the network entity 210). The second information may include or otherwise use a format that is in accordance with the first information. The second information indicative of the HARQ-ACK feedback associated with the second cell group may correspond to the second part or part two of the HARQ-ACK feedback associated with the second cell group.

In the example where the network entity 210 receives the HARQ-ACK feedback associated with the second cell group (e.g., the second part or part two of the HARQ-ACK feedback), the network entity 210 may transmit or otherwise output the HARQ-ACK feedback (e.g., in full or partially, with or without decoding, processing, or performing other functions) to the network entity 215 (e.g., via a backhaul interface). As one non-limiting example, the network entity 210 may decode the second information to identify or otherwise determine at least a portion of the HARQ-ACK feedback associated with the second cell group and transmit or otherwise output the at least the portion of the HARQ-ACK feedback to the second cell (e.g., to the network entity 215). As another non-limiting example, the network entity 210 may obtain at least a portion of the first information from the second cell and decode the second information in accordance with the first information to identify or otherwise determine the HARQ-ACK feedback associated with the second cell group. The network entity 210 may transmit or otherwise output the HARQ-ACK feedback to the second cell (e.g., to the network entity 215).

For example, the HARQ-ACK feedback for the second cell group (e.g., SCG in DC or second PUCCH group in CA) may be transmitted in the following manner. The original HARQ-ACK payload x^{N} may consist of N ACK/NACK bits (e.g., corresponding to N PDSCH transmissions, TBs, code block groups, codebooks of one or more CCs of the second cell group). x^{N} may first be converted to a part one HARQ-ACK feedback

$$( {x}_{1}^{N} ,$$

with length of N₁) and a part two HARQ-ACK feedback

$$( {x}_{2}^{N} ,$$

with length of N₂). The part one HARQ-ACK feedback may correspond to the first information indicative of the HARQ-ACK feedback associated with the second cell group and the part two HARQ-ACK feedback may correspond to the second information indicating of the HARQ-ACK feedback associated with the second cell group.

The UE 205 may transmit the part one HARQ-ACK feedback (e.g., the first information) on the PUCCH cell (e.g., the network entity 215) of the second cell group (e.g., PSCell in DC or PUCCH cell in CA). The part one may be sent as a normal UCI. For example, the part one may be sent using a PUCCH resources of the PUCCH cell of the second cell group.

The part one may be multiplexed on a PUSCH of any of the CCs of the second cell group when the PUCCH resources overlaps with the PUSCH. The UE 205 may transmit the part two HARQ-ACK feedback (e.g., the second information) on the PUCCH cell (e.g., the network entity 210) of the first cell group or on a PUSCH of one of the CCs of the first cell group. That is, the part two may be sent as a normal UCI in some examples (e.g., the part two may be sent on a PUCCH resource of the PUCCH cell of the first cell group). In some examples, the part two HARQ-ACK feedback may be multiplexed on a PUSCH of any of the CCs of the first cell group when the PUCCH resource overlaps with the PUSCH. Alternatively, the part two may be sent in a MAC-CE on a PUSCH of one of the CCs of the first cell group.

In some aspects, the part one of the HARQ-ACK feedback may be designed such that it has a much smaller payload as compared to the original HARQ-ACK feedback (e.g., N₁<<N) so that it can go through (e.g., be successfully communicated) on the second PUCCH cell (e.g., in the high-band cell group). In that aspect, part one may be considered a compressed version of the original HARQ-ACK feedback. Once the high-band DU/RU (e.g., the network entity 215) decodes the part one (e.g., the first information) given the smaller payload, the network may be able to reuse the HARQ process identifiers (or a subset of HARQ process identifiers) with a high likelihood of success. That is, the part one of the HARQ-ACK feedback should be able to indicate the full ACK/NACK information for all or a subset of HARQ process identifiers for typical or likely cases (e.g., at least for the most likely outcomes).

Accordingly, the part one HARQ-ACK feedback may support different design options according to aspects of the techniques described herein. One non-limiting example may include the first information (e.g., the part one) including bundled information in accordance with a logical operation applied to a set of bits in the HARQ-ACK feedback associated with the second cell group. For example, bundling (e.g., logical AND operation) may be applied to the whole N bits such that N₁ is one bit. That is, the bundled information may include a single bit that indicates whether each bit in the set of bits are associated with an ACK indication.

In another non-limiting example, the first information may include bundled information in accordance with a logical operation applied to a set of bits in each block of a set of blocks in the HARQ-ACK feedback associated with the second cell group. For example, bundling (e.g., logical AND operation) may be applied to different blocks of the N bits separately (e.g., bundling across k bits) such that N/is equal to the number of blocks. That is, the bundled information may include a single bit for each block in the set of blocks indicating whether each bit in the set of bits for that block are associated with an ACK indication.

In another non-limiting example, the first information may include an indication of at least one of the HARQ-ACK feedback when the HARQ-ACK feedback is in a first bit value set or an indication that the HARQ-ACK feedback is not in the first bit value set. For example, the part one may distinguish the first likely outcomes (X outcomes) while all remaining outcomes are combined together such that N₁=┌log₂(X+1)┐. Given the probability of an ACK indication is more than a NACK indication when the target downlink BLER is 10% and assuming independent ACK/NACKs, the part one may distinguish all possibilities with up to M NACKs. Therefore.

$$X = {\sum }_{m = 0}^{M} ( \begin{matrix}N \\ m\end{matrix} ) .$$

Accordingly, in some aspects the first bit value set may correspond to a set of outcomes (e.g., X outcomes) for the HARQ-ACK feedback that satisfy a likelihood threshold. In some aspects the first bit value set may correspond to HARQ-ACK feedback comprising a threshold number of NACK indications.

In another non-limiting example, the first information may include an indication of at least one of, for each block in a set of blocks in the HARQ-ACK feedback associated with the second cell group, the HARQ-ACK feedback when the HARQ-ACK feedback for the block is in a first bit value set or an indication that the HARQ-ACK feedback for the block is not in the first bit value set. That is, in this example the bit value set corresponding to the most likely outcomes may be applied to different blocks of the N bits separately. Accordingly, in some aspects the first bit value set for each block in the set of blocks may correspond to a set of outcomes for the HARQ-ACK feedback that satisfies a likelihood threshold. In some aspects, the first bit value set may correspond to, for each block in the set of blocks, the HARQ-ACK feedback for the block that includes a threshold number of NACK indications.

In another non-limiting example, the first information may include a first set of one or more bits that identify a group index for a set of groups. For example, the first set of one or more bits may include a fixed quantity of bits and each bit combination in the first set of one or more bits may correspond to a different group in the set of groups. That is, in this example the part one of the HARQ-ACK feedback may indicate or otherwise identify a group index.

Accordingly, the part one of the HARQ-ACK feedback (e.g., the first information) may take different designs or forms and therefore be used to convey different information indicative of the HARQ-ACK feedback associated with the second cell group. Generally, the second cell (e.g., the network entity 215) may be able to use the first information to immediately reuse the HARQ process identifiers associated with some or all of the CCs or cells in the second cell group. However, in some situations there is a relatively small probability that the part one indication does not allow the high-band DU/RU to reuse the HARQ process identifiers (e.g., the network cannot tell which of the corresponding bits are ACKs or NACKs). In this situation, the part two of the HARQ-ACK feedback associated with the second cell group that is sent on the low-band cell group (e.g., to the first cell in the first cell group) may be used. For example, the network (e.g., the high-band DU/RU) may have two choices: either blindly retransmit downlink data by assuming all bits were NACK indications or waiting for the part two of the HARQ-ACK feedback to be forwarded by the low-band DU/RU (e.g., forwarded by the first cell).

Accordingly, the design of the part two of the HARQ-ACK feedback may depend on various considerations. One consideration is whether minimizing the size of the part two is needed given that the low-band cell group (e.g., the first cell group) may not have any uplink coverage issues. If minimizing the size of part two is not needed, the part two may simply indicate the full HARQ-ACK payload without further optimizations. Another consideration is whether or not the part two HARQ-ACK size should be fixed (e.g., not a function of the part one HARQ-ACK payload). If the part two size is fixed, this means that decoding part one by the second cell (e.g., the high-band DU/RU) and forwarding this to the first cell (e.g., the low-band DU/RU) is not needed for the low-band DU/RU to be able to decode part two. If the part two size is not fixed, the average payload of part one and part two may be minimized, but at the cost of additional latency for decoding the part two.

One option for the design of part two of the HARQ-ACK feedback associated with the second cell group may include the second information indicating the HARQ-ACK feedback associated with the second cell group. For example, the part two HARQ-ACK feedback may be the full HARQ-ACK payload such that

$${x}_{2}^{{N}_{2}} = {x}^{N}$$

(hence, N₂=N).

Another option for the design of part two of the HARQ-ACK feedback associated with the second cell group may include the second information indicating an indication of whether the first information indicates the HARQ-ACK feedback associated with the second cell group. That is, the part two HARQ-ACK feedback may indicate whether or not the part one HARQ-ACK feedback uniquely determines the full HARQ-ACK payload. If not, the part two may indicate or otherwise distinguish (e.g., fully or partially) the possibilities (e.g., the outcomes in the bit value sets) that are not indicated or otherwise distinguished by the part one of the HARQ-ACK feedback associated with the second cell group. For example, the size of the part two HARQ-ACK feedback may not be a function of the part one HARQ-ACK feedback payload. Therefore, the low-band DU/RU (e.g., the network entity 210) can decode the part two without waiting for the high-band DU/RU (e.g., the network entity 215) to decode the part one and forward it to the low-band DU/RU.

When the part one distinguishes the most likely outcomes (e.g., as discussed above), the part two may indicate or otherwise distinguish the next Y most likely outcomes. If fully distinguishing the remaining possibilities, Y=2^{N}−X and N₂=┌log₂(1+2^{N}−X)┐. The +1 parameter may be due to and additional codepoint that indicates the part one HARQ-ACK feedback already uniquely determines the full HARQ-ACK feedback payload (e.g., among the first X possibilities). When the part two partially distinguishes the remaining possibilities, N₂=┌log₂(1+Y+1)┐. The first +1 parameter may again be due to the additional codepoint that indicates the part one HARQ-ACK feedback already uniquely indicates or otherwise determines the full HARQ-ACK feedback payload (e.g., among the first X possibilities). The second +1 parameter may be due to the additional codepoint that indicates the HARQ-ACK feedback payload is not among the X+Y possibilities. For example, if the part one distinguishes the possibilities with up to M NACKs (as discussed above), and the part two distinguishes the possibilities with M+1, . . . , M+M₁ NACKs (as discussed above), then

$$Y = {\sum }_{m = M + 1}^{M + {M}_{1}} ( \begin{matrix}N \\ m\end{matrix} ) .$$

Accordingly, in some aspects the second information may include an indication of whether the HARQ-ACK feedback is in a first bit value set or is in a second bit value set and, when the HARQ-ACK feedback is in the second bit value set, the HARQ-ACK feedback associated with the second cell group. The second bit value set may include either a full set of bit values excluded from the first bit value set or a subset of bit values excluded from the first bit value set.

Another option for the design of part two of the HARQ-ACK feedback associated with the second cell group may include the second information having a variable size and indicating a member of the group that was indicated in the part one HARQ-ACK feedback.

In some aspects, the UE 205 may be (pre) configured (e.g., using RRC signaling or other signaling) with this operation including the associated parameters. For example, the UE 205 may receive or otherwise obtain (and the network entity 210 may transmit or otherwise output) RRC signaling that activates the UE 205 to transmit the first information (e.g., the part one) to the second cell and to transmit the second information (e.g., the part two) to the first cell. For example, the UE 205 may be (pre) configured with a block size (k), with the value of X or M, with the value of Y or M₁, with the group index and group size, with the value of N₁ and/or N₂, via the RRC or other signaling. In some aspects, the UE 205 may be (pre) configured with which design option to utilize for part one and/or part two. In some aspects, such parameters or options may be configured differently for different values of N (e.g., the original HARQ-ACK payload size).

In some aspects, the UE 205 may indicate its support for these features or operations described herein using UE capability signaling. For example, the UE 205 may transmit or otherwise output (and the network entity 210 may receive or otherwise obtain) UE capability signaling that carries or otherwise conveys an indication of support for transmitting the first information to the second cell and for transmitting the second information to the first cell. The network entity 210 may, based on the UE capability signaling, provide the configuration for the UE 205 to communicate via the first cell group and the second cell group.

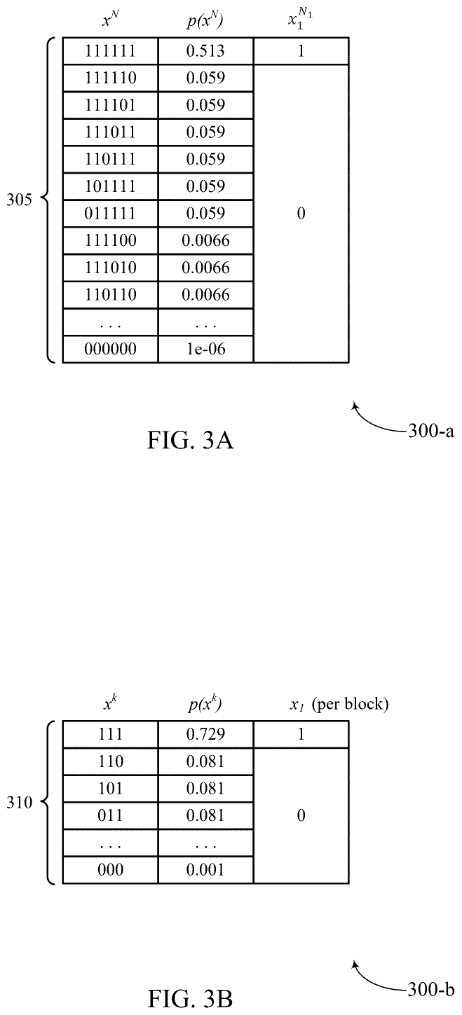

FIGS. 3A and 3B show examples of a HARQ configuration 300 that supports two-part HARQ-ACK in multi-cell groups in accordance with one or more aspects of the present disclosure. HARQ configuration 300 may implement aspects of wireless communications system 100 or wireless communications system 200. Aspects of HARQ configuration 300 may be implemented at or implemented by a UE or a network entity, which may be examples of the corresponding devices described herein. For example, the network entity may be an example of a first cell in a first cell group (e.g., a low-band DU/RU) or an example of a second cell in a second cell group (e.g., a high-band DU/RU).

As discussed above, the techniques described herein provide for two-part HARQ-ACK feedback associated with a second cell group where the first part is sent to the second cell of the second cell group and the second part is sent to the first cell of the first cell group. For example, the UE may receive or otherwise obtain (and the network entity, such as the first cell in the first cell group, may transmit or otherwise output) signaling indicating a configuration for communications via the first cell group and a second cell group. The signaling may include RRC signaling or other signaling between the UE and the network entity. The configuration for multi-cell group communications may include configuring the UE for communications according to a DC scenario or a CA scenario. For example, the first cell group may be an MCG in a DC deployment scenario or may be a primary/first PUCCH group in a CA scenario with two PUCCH cell groups. The first cell group may include a first cell that may be the PCell for this cell group (e.g., carries uplink control on PUCCH for all downlink CCs in this cell group). For example, the first cell may be used for transmission (e.g., by the UE) of HARQ-ACK feedback associated with the first cell group. The network entity may be an example of the first cell in the first cell group in this example.

The second cell group may be a SCG in the DC scenario or a second PUCCH group in the CA scenario with two PUCCH groups. The second cell group may include a second cell that may be the PSCell for the DC scenario or the PUCCH SCell in the CA scenario with two PUCCH groups (e.g., carries uplink control on PUCCH for all downlink CCs in this cell group). For example, the second cell may be used for transmission of HARQ-ACK feedback associated with the second cell group. The network entity may be an example of the second cell in the second cell group in this example.

The UE may transmit or otherwise output first information indicative of the HARQ-ACK feedback associated with the second cell group to the second cell. The first information may have a first payload size that is smaller than a second payload size of the HARQ-ACK feedback associated with the second cell group. The first information indicative of the HARQ-ACK feedback associated with the second cell group may correspond to the first part or part one of the HARQ-ACK feedback associated with the second cell group.

The UE may transmit or otherwise output second information indicative of the HARQ-ACK feedback associated with the second cell group to the first cell. The second information may include or otherwise use a format that is in accordance with the first information. The second information indicative of the HARQ-ACK feedback associated with the second cell group may correspond to the second part or part two of the HARQ-ACK feedback associated with the second cell group.

In the example where the first cell receives the HARQ-ACK feedback associated with the second cell group (e.g., the second part or part two of the HARQ-ACK feedback), the first cell may transmit or otherwise output the HARQ-ACK feedback (e.g., in full or partially, with or without decoding, processing, or performing other functions) to the second cell (e.g., via a backhaul interface). As one non-limiting example, the first cell may decode the second information to identify or otherwise determine at least a portion of the HARQ-ACK feedback associated with the second cell group and transmit or otherwise output the at least the portion of the HARQ-ACK feedback to the second cell. As another non-limiting example, the first cell may obtain at least a portion of the first information from the second cell and decode the second information in accordance with the first information to identify or otherwise determine the HARQ-ACK feedback associated with the second cell group. The first cell may transmit or otherwise output the HARQ-ACK feedback to the second cell.

As discussed above, aspects of the techniques described herein provide various mechanisms for consideration of the design of part one and/or part two of the HARQ-ACK feedback associated with the second cell group. HARQ configuration 300-a of FIG. 3A illustrates a non-limiting example where the design of the first part includes the first information indicating bundled information in accordance with a logical operation applied to a set of bits in the HARQ-ACK feedback associated with the second cell group. HARQ configuration 300-b of FIG. 3B illustrates a non-limiting example where the design of the first part includes the first information including bundled information in accordance with a logical operation applied to a set of bits in each block in the HARQ-ACK feedback associated with the second cell group.

Turning first to the HARQ configuration 300-a of FIG. 3A, this may include bundling (e.g., based on application of a logical AND function) being applied to the whole N bits such that N₁ is one bit. In particular, FIG. 3A illustrates a table 305 that shows examples of the application of the logical AND operation to the set of bits in the HARQ-ACK feedback associated with the second cell group. In this example, N₁=1 and the high-band DU/RU (e.g., the second cell) may reuse the HARQ process identifiers associated with the original HARQ-ACK feedback payload. As shown, for six HARQ process identifiers (x^{N}), there is a probability (p(x^{N})) of 0.5314 that the part one

$$( {x}_{1}^{{N}_{1}} )$$

indicates a “1” which corresponds to all ACKs for the six HARQ process identifiers (e.g., with a BLER target of 10%). That is, the UE may apply a logical AND operation to the six bits corresponding to the HARQ-ACK codebook to determine whether the part one HARQ-ACK feedback associated with the second cell group is all ACK indications. There is roughly a 53% chance that the HARQ-ACK feedback will be all ACKs, and therefore this is an efficient mechanism to indicate the HARQ-ACK feedback associated with the second cell group to the second cell in a manner that permits reuse of those six HARQ process identifiers.

As also shown, in the event there is one or more NACK indications in the HARQ-ACK feedback associated with the second cell group, the part one may indicate a “0” to signal that there is at least one NACK in the HARQ-ACK feedback. If the part one HARQ-ACK feedback indicates a “0” (e.g., with a probability of 0.4686), the high-band DU/RU (e.g., the second cell) cannot immediately reuse these HARQ process identifiers unless it assumes all NACK indications and retransmits all corresponding PDSCHs.

Turning next to the HARQ configuration 300-b of FIG. 3B, this may include bundling (e.g., based on application of a logical AND function) being applied to different blocks of the N bits separately (e.g., bundled across k bits) where N corresponds to the number of blocks. In particular, FIG. 3B illustrates a table 310 that shows examples of the application of the logical AND operation to the set of bits (x^{k}) of different blocks in the HARQ-ACK feedback associated with the second cell group. In this example, the set of bits in each block may include three bits and bundling is applied to each block separately. There is a probability (p(x^{k})) of 0.729 that the three bits in the illustrated block will be all ACK indications. In that situation, the UE may indicate a “1” (x₁) for that block to the second cell.

In some examples, N₁=2 as there are at least two blocks. If the part one indicates “11” (e.g., with a probability of 0.7292=0.5314), the high-band DU/RU can reuse all six HARQ process identifiers. If the part one indicates a “10” or “01” (e.g., with a probability of 0.729*(1−0.729)*2=0.3951), the high-band DU/RU can reuse three of the HARQ process identifiers associated with the bundled ACK block. For the bundled NACK block (e.g., the other three HARQ process identifiers), the high-band DU/RU cannot immediately reuse these HARQ process identifiers unless it assumes all NACK indications and retransmits all corresponding PDSCHs. If the part one indicates “00” (e.g., with a probability of 0.0734), the high-band DU/RU cannot immediately reuse these six HARQ process identifiers unless it assumes all NACK indications and retransmits all corresponding PDSCHs. Accordingly, in this example the bundled information includes a single bit for each block in the set of blocks that indicates whether each bit in the set of bits for that block are associated with an ACK indication.

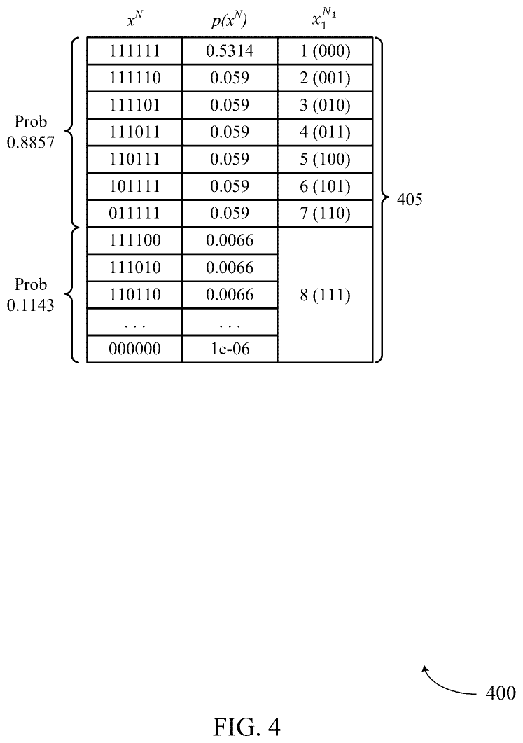

FIG. 4 shows an example of a HARQ configuration 400 that supports two-part HARQ-ACK in multi-cell groups in accordance with one or more aspects of the present disclosure. HARQ configuration 400 may implement aspects of wireless communications system 100 or wireless communications system 200 or aspects of HARQ configuration 300. Aspects of HARQ configuration 400 may be implemented at or implemented by a UE or a network entity, which may be examples of the corresponding devices described herein. For example, the network entity may be an example of a first cell in a first cell group (e.g., a low-band DU/RU) or an example of a second cell in a second cell group (e.g., a high-band DU/RU).

As discussed above, the techniques described herein provide for two-part HARQ-ACK feedback associated with a second cell group where the first part is sent to the second cell of the second cell group and the second part is sent to the first cell of the first cell group. For example, the UE may receive or otherwise obtain (and the network entity, such as the first cell in the first cell group, may transmit or otherwise output) signaling indicating a configuration for communications via the first cell group and a second cell group. The signaling may include RRC signaling or other signaling between the UE and the network entity. The configuration for multi-cell group communications may include configuring the UE for communications according to a DC scenario or a CA scenario. For example, the first cell group may be an MCG in a DC deployment scenario or may be a primary/first PUCCH group in a CA scenario with two PUCCH cell groups. The first cell group may include a first cell that may be the PCell for this cell group (e.g., carries uplink control on PUCCH for all downlink CCs in this cell group). For example, the first cell may be used for transmission (e.g., by the UE) of HARQ-ACK feedback associated with the first cell group. The network entity may be an example of the first cell in the first cell group in this example.

The second cell group may be a SCG in the DC scenario or a second PUCCH group in the CA scenario with two PUCCH groups. The second cell group may include a second cell that may be the PSCell for the DC scenario or the PUCCH SCell in the CA scenario with two PUCCH groups (e.g., carries uplink control on PUCCH for all downlink CCs in this cell group). For example, the second cell may be used for transmission of HARQ-ACK feedback associated with the second cell group. The network entity may be an example of the second cell in the second cell group in this example.

The UE may transmit or otherwise output first information indicative of the HARQ-ACK feedback associated with the second cell group to the second cell. The first information may have a first payload size that is smaller than a second payload size the HARQ-ACK feedback associated with the second cell group. The first information indicative of the HARQ-ACK feedback associated with the second cell group may correspond to the first part or part one of the HARQ-ACK feedback associated with the second cell group.

The UE may transmit or otherwise output second information indicative of the HARQ-ACK feedback associated with the second cell group to the first cell. The second information may include or otherwise use a format that is in accordance with the first information. The second information indicative of the HARQ-ACK feedback associated with the second cell group may correspond to the second part or part two of the HARQ-ACK feedback associated with the second cell group.

In the example where the first cell receives the HARQ-ACK feedback associated with the second cell group (e.g., the second part or part two of the HARQ-ACK feedback), the first cell may transmit or otherwise output the HARQ-ACK feedback (e.g., in full or partially, with or without decoding, processing, or performing other functions) to the second cell (e.g., via a backhaul interface). As one non-limiting example, the first cell may decode the second information to identify or otherwise determine at least a portion of the HARQ-ACK feedback associated with the second cell group and transmit or otherwise output the at least the portion of the HARQ-ACK feedback to the second cell. As another non-limiting example, the first cell may obtain at least a portion of the first information from the second cell and decode the second information in accordance with the first information to identify or otherwise determine the HARQ-ACK feedback associated with the second cell group. The first cell may transmit or otherwise output the HARQ-ACK feedback to the second cell.

As discussed above, aspects of the techniques described herein provide various mechanisms for considerations for the design of part one and/or part two of the HARQ-ACK feedback associated with the second cell group. HARQ configuration 400 illustrates a non-limiting example where the design of the first part includes the first information indicating at least one of the HARQ-ACK feedback when the HARQ-ACK feedback is in a first bit value set or indicating that the HARQ-ACK feedback is not in the first bit value set. That is, the first bit value set may correspond to a set of outcomes for the HARQ-ACK feedback that satisfy a likelihood threshold or a threshold number of NACK indications.

This may include the part one identifying or otherwise distinguishing the most likely X outcomes while all remaining outcomes are combined together such that N₁=┌log₂(X+1)┐. In particular, FIG. 4 illustrates a table 405 that shows that, given the probability of ACK is more than NACK when the target BLER is 10% and assuming independent ACK/NACKs, the part one can distinguish all possibilities with up to M NACKs. Hence,

$$X = {\sum }_{m = 0}^{M} ( \begin{matrix}N \\ m\end{matrix} ) .$$

In particular, in this example X=7 (e.g., the first seven most likely payloads out of the 2\hat{ }6=64 possible payloads) and therefore N₁=┌log₂(7+1)┐=3. That is, three bits may be used to indicate the part one of the HARQ-ACK feedback associated with the second cell group where the three bits identify or otherwise distinguish the X most likely outcomes.

The part one may indicate one of the most likely seven possible outcomes or not among the seven possible outcomes (e.g., eight possible outcomes are indicated in total). In this example, the most likely outcome are up to M=1 NACKs (hence, all ACKs or 5 ACKs plus one NACK are distinguished). If the part one indicates one of these seven most likely outcomes by indicating “000,” “001,” “010,” “011,” “100,” “101,” or “110” (e.g., with a probability of 0.8857), the high-band DU/RU can reuse all six of these HARQ process identifiers.

If the part one indicates the last possibility by indicating “111” or not among the likely possibilities (e.g., which happens with a probability of 0.1143), the high-band DU/RU cannot immediately reuse these six HARQ process identifiers unless it assumes all NACKs and retransmits all corresponding PDSCHs.

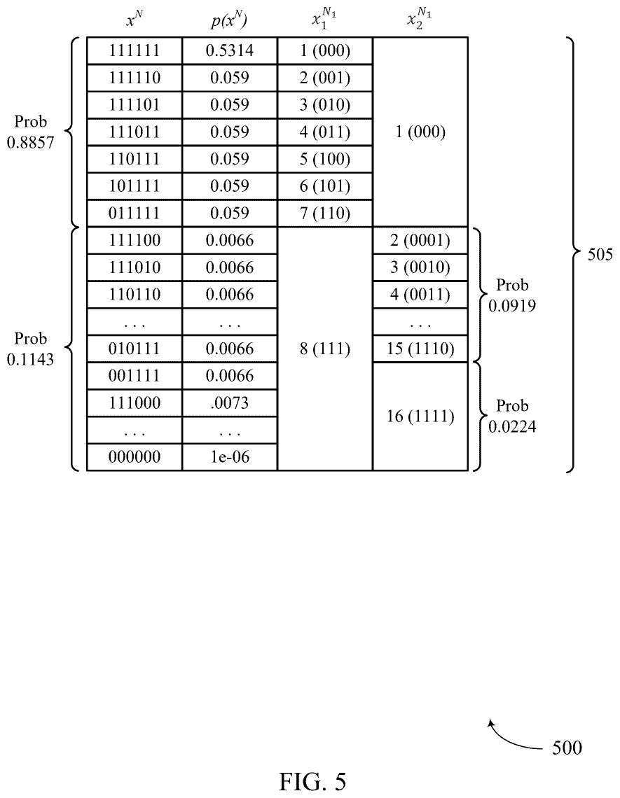

FIG. 5 shows an example of a HARQ configuration 500 that supports two-part HARQ-ACK in multi-cell groups in accordance with one or more aspects of the present disclosure. HARQ configuration 500 may implement aspects of wireless communications system 100 or wireless communications system 200 or aspects of HARQ configuration 300 or HARQ configuration 400. Aspects of HARQ configuration 500 may be implemented at or implemented by a UE or a network entity, which may be examples of the corresponding devices described herein. For example, the network entity may be an example of a first cell in a first cell group (e.g., a low-band DU/RU) or an example of a second cell in a second cell group (e.g., a high-band DU/RU).

As discussed above, the techniques described herein provide for two-part HARQ-ACK feedback associated with a second cell group where the first part is sent to the second cell of the second cell group and the second part is sent to the first cell of the first cell group. For example, the UE may receive or otherwise obtain (and the network entity, such as the first cell in the first cell group, may transmit or otherwise output) signaling indicating a configuration for communications via the first cell group and a second cell group. The signaling may include RRC signaling or other signaling between the UE and the network entity. The configuration for multi-cell group communications may include configuring the UE for communications according to a DC scenario or a CA scenario. For example, the first cell group may be an MCG in a DC deployment scenario or may be a primary/first PUCCH group in a CA scenario with two PUCCH cell groups. The first cell group may include a first cell that may be the PCell for this cell group (e.g., carries uplink control on PUCCH for all downlink CCs in this cell group). For example, the first cell may be used for transmission (e.g., by the UE) of HARQ-ACK feedback associated with the first cell group. The network entity may be an example of the first cell in the first cell group in this example.

The second cell group may be a SCG in the DC scenario or a second PUCCH group in the CA scenario with two PUCCH groups. The second cell group may include a second cell that may be the PSCell for the DC scenario or the PUCCH SCell in the CA scenario with two PUCCH groups (e.g., carries uplink control on PUCCH for all downlink CCs in this cell group). For example, the second cell may be used for transmission of HARQ-ACK feedback associated with the second cell group. The network entity may be an example of the second cell in the second cell group in this example.

The UE may transmit or otherwise output first information indicative of the HARQ-ACK feedback associated with the second cell group to the second cell. The first information may have a first payload size that is smaller than a second payload size the HARQ-ACK feedback associated with the second cell group. The first information indicative of the HARQ-ACK feedback associated with the second cell group may correspond to the first part or part one of the HARQ-ACK feedback associated with the second cell group.

The UE may transmit or otherwise output second information indicative of the HARQ-ACK feedback associated with the second cell group to the first cell. The second information may include or otherwise use a format that is in accordance with the first information. The second information indicative of the HARQ-ACK feedback associated with the second cell group may correspond to the second part or part two of the HARQ-ACK feedback associated with the second cell group.

In the example where the first cell receives the HARQ-ACK feedback associated with the second cell group (e.g., the second part or part two of the HARQ-ACK feedback), the first cell may transmit or otherwise output the HARQ-ACK feedback (e.g., in full or partially, with or without decoding, processing, or performing other functions) to the second cell (e.g., via a backhaul interface). As one non-limiting example, the first cell may decode the second information to identify or otherwise determine at least a portion of the HARQ-ACK feedback associated with the second cell group and transmit or otherwise output the at least the portion of the HARQ-ACK feedback to the second cell. As another non-limiting example, the first cell may obtain at least a portion of the first information from the second cell and decode the second information in accordance with the first information to identify or otherwise determine the HARQ-ACK feedback associated with the second cell group. The first cell may transmit or otherwise output the HARQ-ACK feedback to the second cell.

As discussed above, aspects of the techniques described herein provide various mechanisms for considerations for the design of part one and/or part two of the HARQ-ACK feedback associated with the second cell group. This may include the part two indicating whether the part one HARQ-ACK feedback uniquely determines the full HARQ-ACK feedback payload or not and, if not, indicting or otherwise distinguishing (e.g., fully or partially) the possibilities that are not distinguished by part one. In particular, FIG. 5 illustrates a table 505 that shows the second information indicating whether the first information indicates the HARQ-ACK feedback associated with the second cell group. For example, the table 505 shows a non-limiting example where the second information indicates whether the HARQ-ACK feedback is in a first bit value set (e.g., the first bit value set includes the first seven rows of x^{N} of the first column) or is in a second bit value set (e.g., the next fourteen rows, after the seventh row, of the original HARQ-ACK feedback/first column) and, when the HARQ-ACK feedback is in the second bit value set, the HARQ-ACK feedback.

That is, in this example X=7 and Y=14 and hence N₁=┌log₂(7+1)┐=3 and N₂=┌log₂(1+14+1)┐=4. If the part one indicates one of the first seven most likely outcomes (e.g.,

$${x}_{1}^{{N}_{1}}$$

indicates “000,” “001,” “010,” “011,” “100,” “101,” or “110,” which may correspond to the first bit value set) with a probability of 0.8857, the high-band DU/RU may reuse all six HARQ process identifiers. Accordingly, in this situation the part two may indicate “0000” to identify that the part one has already uniquely determined the full HARQ-ACK feedback payload. Hence, the low-band DU/RU does not need to forward the part two to the high-band DU/RU.

If the part one indicates the last possibility (e.g., “111” or not among the first seven possibilities), which happens with a probability of 0.1143, then the format of the part two may take different forms. For example, if the part two indicates one of the next 14 most likely possibilities (e.g., the second bit value set, which happens with a probability of 0.0919), once the low-band DU/RU decodes and forwards the part two to the high-band DU/RU, all corresponding HARQ process identifiers can be reused (e.g., as the full HARQ-ACK feedback payload is known). If the part two indicates the last possibility (e.g., “1111” or not among the next 14 possibilities), which happens with a probability of 0.0224), the high-band DU/RU cannot use these six HARQ process identifiers (e.g., even after the part two is forwarded by the low-band DU/RU) unless it assumes all NACKs and retransmits all corresponding PDSCHs.

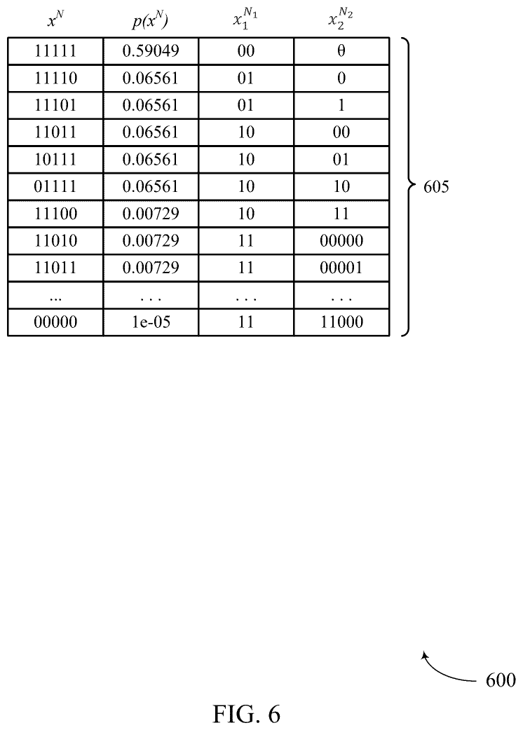

FIG. 6 shows an example of a HARQ configuration 600 that supports two-part HARQ-ACK in multi-cell groups in accordance with one or more aspects of the present disclosure. HARQ configuration 600 may implement aspects of wireless communications system 100 or wireless communications system 200 or aspects of HARQ configuration 300, HARQ configuration 400 or HARQ configuration 500. Aspects of HARQ configuration 600 may be implemented at or implemented by a UE or a network entity, which may be examples of the corresponding devices described herein. For example, the network entity may be an example of a first cell in a first cell group (e.g., a low-band DU/RU) or an example of a second cell in a second cell group (e.g., a high-band DU/RU).

As discussed above, the techniques described herein provide for two-part HARQ-ACK feedback associated with a second cell group where the first part is sent to the second cell of the second cell group and the second part is sent to the first cell of the first cell group. For example, the UE may receive or otherwise obtain (and the network entity, such as the first cell in the first cell group, may transmit or otherwise output) signaling indicating a configuration for communications via the first cell group and a second cell group. The signaling may include RRC signaling or other signaling between the UE and the network entity. The configuration for multi-cell group communications may include configuring the UE for communications according to a DC scenario or a CA scenario. For example, the first cell group may be an MCG in a DC deployment scenario or may be a primary/first PUCCH group in a CA scenario with two PUCCH cell groups. The first cell group may include a first cell that may be the PCell for this cell group (e.g., carries uplink control on PUCCH for all downlink CCs in this cell group). For example, the first cell may be used for transmission (e.g., by the UE) of HARQ-ACK feedback associated with the first cell group. The network entity may be an example of the first cell in the first cell group in this example.

The second cell group may be a SCG in the DC scenario or a second PUCCH group in the CA scenario with two PUCCH groups. The second cell group may include a second cell that may be the PSCell for the DC scenario or the PUCCH SCell in the CA scenario with two PUCCH groups (e.g., carries uplink control on PUCCH for all downlink CCs in this cell group). For example, the second cell may be used for transmission of HARQ-ACK feedback associated with the second cell group. The network entity may be an example of the second cell in the second cell group in this example.

The UE may transmit or otherwise output first information indicative of the HARQ-ACK feedback associated with the second cell group to the second cell. The first information may have a first payload size that is smaller than a second payload size the HARQ-ACK feedback associated with the second cell group. The first information indicative of the HARQ-ACK feedback associated with the second cell group may correspond to the first part or part one of the HARQ-ACK feedback associated with the second cell group.

The UE may transmit or otherwise output second information indicative of the HARQ-ACK feedback associated with the second cell group to the first cell. The second information may include or otherwise use a format that is in accordance with the first information. The second information indicative of the HARQ-ACK feedback associated with the second cell group may correspond to the second part or part two of the HARQ-ACK feedback associated with the second cell group.

In the example where the first cell receives the HARQ-ACK feedback associated with the second cell group (e.g., the second part or part two of the HARQ-ACK feedback), the first cell may transmit or otherwise output the HARQ-ACK feedback (e.g., in full or partially, with or without decoding, processing, or performing other functions) to the second cell (e.g., via a backhaul interface). As one non-limiting example, the first cell may decode the second information to identify or otherwise determine at least a portion of the HARQ-ACK feedback associated with the second cell group and transmit or otherwise output the at least the portion of the HARQ-ACK feedback to the second cell. As another non-limiting example, the first cell may obtain at least a portion of the first information from the second cell and decode the second information in accordance with the first information to identify or otherwise determine the HARQ-ACK feedback associated with the second cell group. The first cell may transmit or otherwise output the HARQ-ACK feedback to the second cell.

As discussed above, aspects of the techniques described herein provide various mechanisms for considerations for the design of part one and/or part two of the HARQ-ACK feedback associated with the second cell group. In particular, FIG. 6 illustrates a table 605 that shows where the part one indicates a first set of one or more bits that identify a group index for a set of groups and part two indicating a second set of one or more bits that identify a group member in the set of groups in accordance with the group index. For example, the second set of one or more bits may include a variable quantity of bits and a bit combination in the second set of one or more bits may be in accordance with a quantity of members of the group in accordance with the group index identified by the first information. As is shown in table 605, the first information (e.g., the part one) may include a fixed quantity of bits and each bit combination in the first set of one or more bits may correspond to a different group in the set of groups.

Aspects of these features may support the two-part HARQ-ACK feedback design discussed above where the goal is to minimize the average length of N₁ plus N₂. This may include partitioning the 2^{N} codepoints into 2^{N}^{₁} groups, where group g, 1≤g≤2^{N}^{₁}, includes m_{g} members. The part one (e.g., the first information) may have a fixed length of N₁ bits and the part two (e.g., the second information) may have a variable length (e.g., depending on the size of the group of ┌log₂ m_{g}┐ bits). Given a variable size of part two (e.g., dependent on the payload of part one), this may result in, before the low-band DU/RU can decode the part two, the high-band DU/RU first decodes the part one and forwards this to the low-band DU/RU so that the low-band DU/RU knows the size of the part two. Then the low-band DU/RU decodes the part two and forwards it to the high-band DU/RU. Now the high-band DU/RU can reconstruct the original HARQ-ACK feedback payload from the part one (decoded itself) and the part two (forwarded from the low-band DU/RU). Therefore, there may be a latency issues related to the backhaul latency when the part two is need by the high-band DU/RU.

In the non-limiting example shown in table 605, there may be four groups (N₁=2). The first group

$$( e . g . , {x}_{1}^{{N}_{1}} = “ 00 ” )$$

may nave one member and, therefore the part two is not needed. Therefore, if part one indicates “00,” this may indicate that all HARQ process identifiers can be reused by the high-band DU/RU immediately. The second group has two members

$$( e . g . , {x}_{1}^{{N}_{1}} = “ 01 ” )$$

which results in a one-bit part two

$$( e . g . , {x}_{2}^{{N}_{2}} = “ 0 ” or “ 1 ” ) .$$

If the part one indicates “01,” the first three HARQ process identifiers (e.g., out of five) can be reused by the high-band DU/RU immediately. The third group has four members, which results in a two bit part two and the fourth group has 25 members which results in a five bit part two.

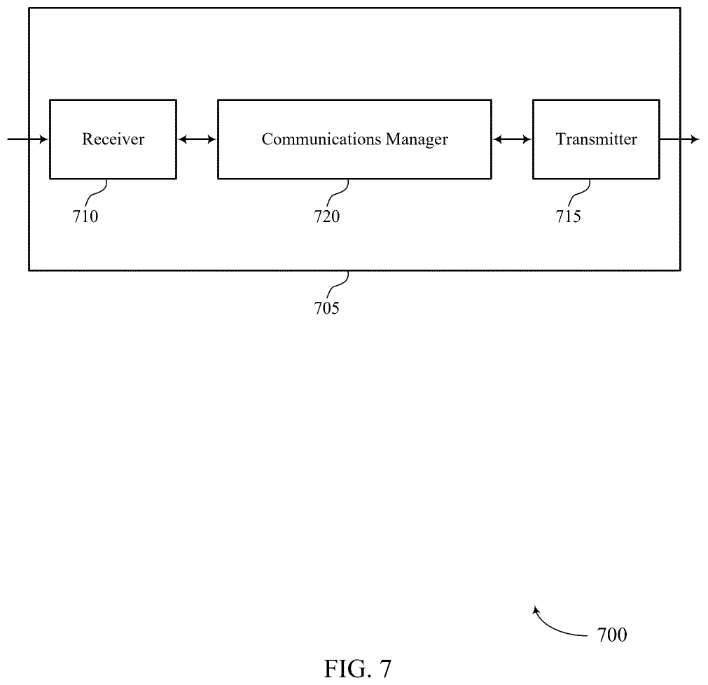

FIG. 7 shows a block diagram 700 of a device 705 that supports two-part HARQ-ACK in multi-cell groups in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to two-part HARQ-ACK in multi-cell groups). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to two-part HARQ-ACK in multi-cell groups). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of two-part HARQ-ACK in multi-cell groups as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving signaling indicating a configuration for communications via a first cell group and a second cell group, the first cell group including a first cell associated with transmission of HARQ-ACK feedback associated with the first cell group and the second cell group including a second cell associated with transmission of HARQ-ACK feedback associated with the second cell group. The communications manager 720 is capable of, configured to, or operable to support a means for transmitting first information indicative of the HARQ-ACK feedback associated with the second cell group to the second cell, where the first information includes a first payload size that is smaller than a second payload size of the HARQ-ACK feedback associated with the second cell group. The communications manager 720 is capable of, configured to, or operable to support a means for transmitting second information indicative of the HARQ-ACK feedback associated with the second cell group to the first cell, where the second information includes a format that is in accordance with the first information.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for two-part HARQ-ACK feedback associated with a second cell group where the first part is sent to the second cell of the second cell group and the second part is sent to the first cell of the first cell group. The first part may have a first payload size that is smaller than the full HARQ-ACK feedback payload size and the second part may have a format that is based on the first part. The second cell (e.g., the high-band DU/RU) may reuse some or all of the HARQ process identifiers based on the first part, in some examples, or based on the first and second parts, in other examples.

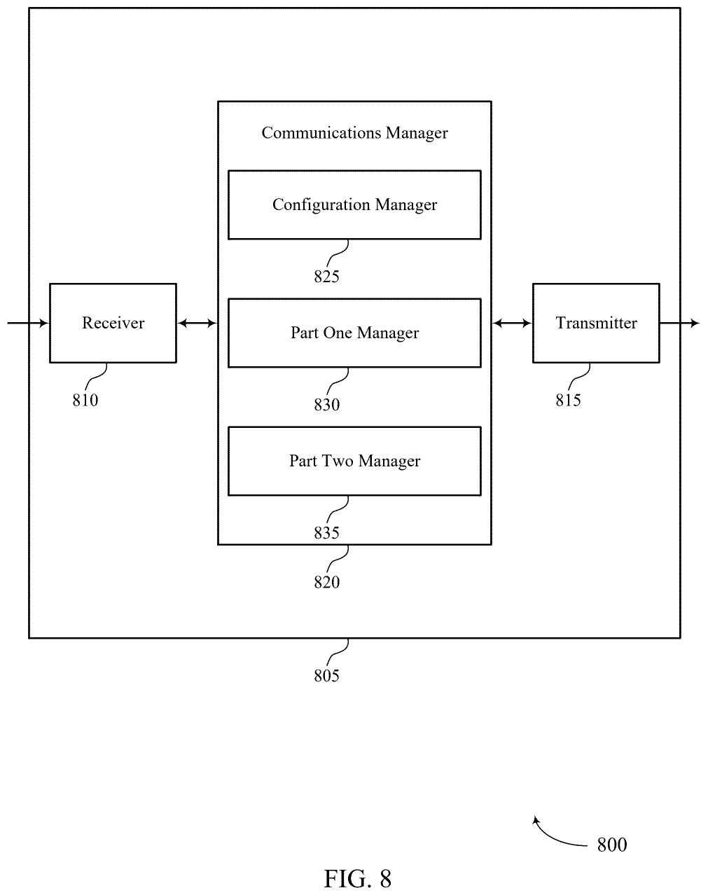

FIG. 8 shows a block diagram 800 of a device 805 that supports two-part HARQ-ACK in multi-cell groups in accordance with one or more aspects of the present disclosure. The device 805 may be an example of aspects of a device 705 or a UE 115 as described herein. The device 805 may include a receiver 810, a transmitter 815, and a communications manager 820. The device 805, or one of more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to two-part HARQ-ACK in multi-cell groups). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to two-part HARQ-ACK in multi-cell groups). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of two-part HARQ-ACK in multi-cell groups as described herein. For example, the communications manager 820 may include a configuration manager 825, a part one manager 830, a part two manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The configuration manager 825 is capable of, configured to, or operable to support a means for receiving signaling indicating a configuration for communications via a first cell group and a second cell group, the first cell group including a first cell associated with transmission of HARQ-ACK feedback associated with the first cell group and the second cell group including a second cell associated with transmission of HARQ-ACK feedback associated with the second cell group. The part one manager 830 is capable of, configured to, or operable to support a means for transmitting first information indicative of the HARQ-ACK feedback associated with the second cell group to the second cell, where the first information includes a first payload size that is smaller than a second payload size of the HARQ-ACK feedback associated with the second cell group. The part two manager 835 is capable of, configured to, or operable to support a means for transmitting second information indicative of the HARQ-ACK feedback associated with the second cell group to the first cell, where the second information includes a format that is in accordance with the first information.

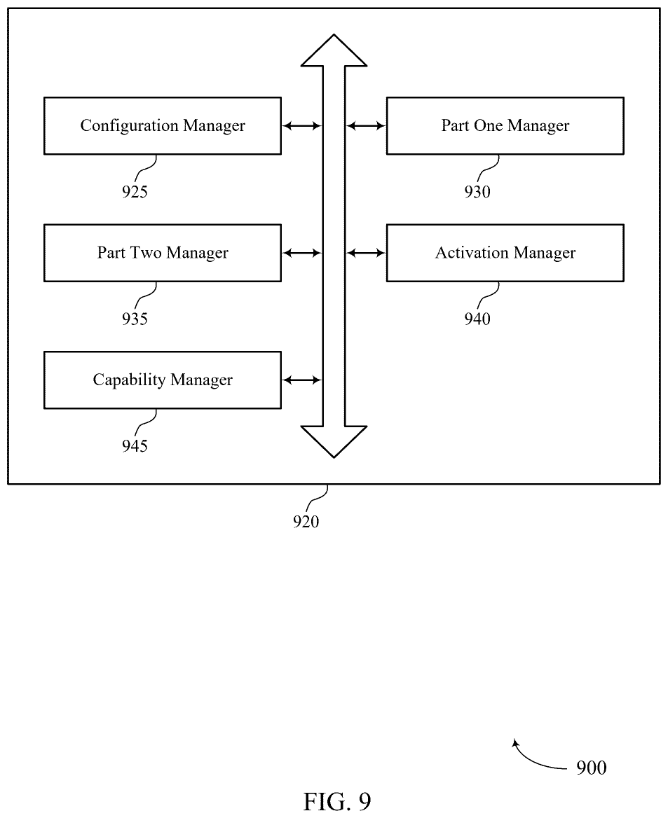

FIG. 9 shows a block diagram 900 of a communications manager 920 that supports two-part HARQ-ACK in multi-cell groups in accordance with one or more aspects of the present disclosure. The communications manager 920 may be an example of aspects of a communications manager 720, a communications manager 820, or both, as described herein. The communications manager 920, or various components thereof, may be an example of means for performing various aspects of two-part HARQ-ACK in multi-cell groups as described herein. For example, the communications manager 920 may include a configuration manager 925, a part one manager 930, a part two manager 935, an activation manager 940, a capability manager 945, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The configuration manager 925 is capable of, configured to, or operable to support a means for receiving signaling indicating a configuration for communications via a first cell group and a second cell group, the first cell group including a first cell associated with transmission of HARQ-ACK feedback associated with the first cell group and the second cell group including a second cell associated with transmission of HARQ-ACK feedback associated with the second cell group. The part one manager 930 is capable of, configured to, or operable to support a means for transmitting first information indicative of the HARQ-ACK feedback associated with the second cell group to the second cell, where the first information includes a first payload size that is smaller than a second payload size of the HARQ-ACK feedback associated with the second cell group. The part two manager 935 is capable of, configured to, or operable to support a means for transmitting second information indicative of the HARQ-ACK feedback associated with the second cell group to the first cell, where the second information includes a format that is in accordance with the first information.

In some examples, the first information includes bundled information in accordance with a logical operation applied to a set of bits in the HARQ-ACK feedback associated with the second cell group. In some examples, the bundled information includes a single bit indicating whether each bit in the set of bits are associated with an ACK indication. In some examples, the first information includes bundled information in accordance with a logical operation applied to a set of bits in each block of a set of blocks in the HARQ-ACK feedback associated with the second cell group. In some examples, the bundled information includes a single bit for each block in the set of blocks indicating whether each bit in the set of bits for that block are associated with an ACK indication. In some examples, the first information includes an indication of at least one of the HARQ-ACK feedback when the HARQ-ACK feedback is in a first bit value set or an indication that the HARQ-ACK feedback is not in the first bit value set.

In some examples, the first bit value set corresponds to a set of outcomes for the HARQ-ACK feedback that satisfies a likelihood threshold. In some examples, the first bit value set corresponds to HARQ-ACK feedback including a threshold number of NACK indications. In some examples, the first information includes an indication of at least one of, for each block in a set of blocks in the HARQ-ACK feedback associated with the second cell group, the HARQ-ACK feedback when the HARQ-ACK feedback for the block is in a first bit value set or an indication that the HARQ-ACK feedback for the block is not in the first bit value set. In some examples, the first bit value set for each block in the set of blocks corresponds to a set of outcomes for the HARQ-ACK feedback that satisfies a likelihood threshold.

In some examples, the first bit value set corresponds to, for each block in the set of blocks, HARQ-ACK feedback for the block including a threshold number of NACK indications. In some examples, the first information includes a first set of one or more bits that identify a group index for a set of groups. In some examples, the first set of one or more bits include a fixed quantity of bits and each bit combination in the first set of one or more bits corresponds to a different group in the set of groups. In some examples, the second information includes a second set of one or more bits that identify a group member of a group in the set of groups in accordance with the group index.

In some examples, the second set of one or more bits include a variable quantity of bits and a bit size of a bit combination in the second set of one or more bits is in accordance with a quantity of members in the group in accordance with the group index identified by the first information. In some examples, the second information includes the HARQ-ACK feedback associated with the second cell group. In some examples, the second information includes an indication of whether the first information indicates the HARQ-ACK feedback associated with the second cell group. In some examples, the second information includes an indication of whether the HARQ-ACK feedback is in a first bit value set or is in a second bit value set and, when the HARQ-ACK feedback is in the second bit value set, the HARQ-ACK feedback.

In some examples, the second bit value set includes either a full set of bit values excluded from the first bit value set or a subset of bit values excluded from the first bit value set. In some examples, the activation manager 940 is capable of, configured to, or operable to support a means for receiving RRC signaling that activates transmitting the first information to the second cell and transmitting the second information to the first cell. In some examples, the capability manager 945 is capable of, configured to, or operable to support a means for transmitting UE capability signaling indicating support for transmitting the first information to the second cell and transmitting the second information to the first cell, where the configuration is in accordance with the UE capability signaling.

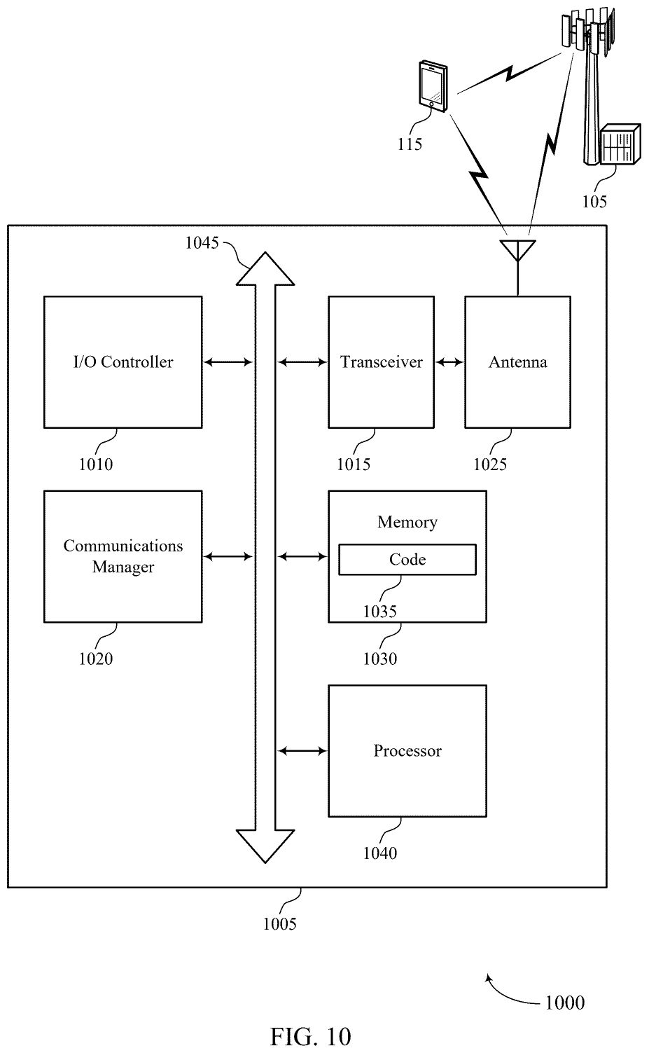

FIG. 10 shows a diagram of a system 1000 including a device 1005 that supports two-part HARQ-ACK in multi-cell groups in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting two-part HARQ-ACK in multi-cell groups). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving signaling indicating a configuration for communications via a first cell group and a second cell group, the first cell group including a first cell associated with transmission of HARQ-ACK feedback associated with the first cell group and the second cell group including a second cell associated with transmission of HARQ-ACK feedback associated with the second cell group. The communications manager 1020 is capable of, configured to, or operable to support a means for transmitting first information indicative of the HARQ-ACK feedback associated with the second cell group to the second cell, where the first information includes a first payload size that is smaller than a second payload size of the HARQ-ACK feedback associated with the second cell group. The communications manager 1020 is capable of, configured to, or operable to support a means for transmitting second information indicative of the HARQ-ACK feedback associated with the second cell group to the first cell, where the second information includes a format that is in accordance with the first information.

By including or configuring the communications manager 1020 in accordance with examples as described herein, the device 1005 may support techniques for two-part HARQ-ACK feedback associated with a second cell group where the first part is sent to the second cell of the second cell group and the second part is sent to the first cell of the first cell group. The first part may have a first payload size that is smaller than the full HARQ-ACK feedback payload size and the second part may have a format that is based on the first part. The second cell (e.g., the high-band DU/RU) may reuse some or all of the HARQ process identifiers based on the first part, in some examples, or based on the first and second parts, in other examples.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of two-part HARQ-ACK in multi-cell groups as described herein, or the at least one processor 1040 and the at least one memory 1030 may be otherwise configured to, individually or collectively, perform or support such operations.

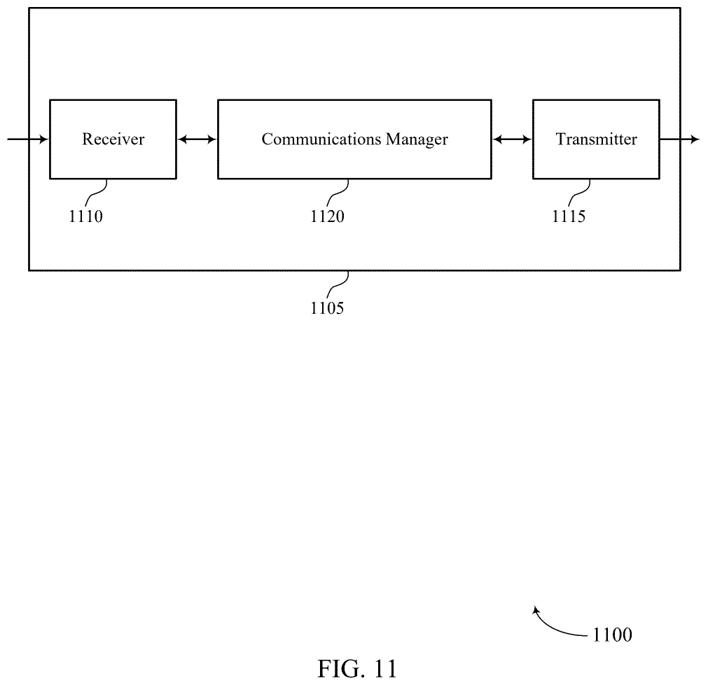

FIG. 11 shows a block diagram 1100 of a device 1105 that supports two-part HARQ-ACK in multi-cell groups in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of two-part HARQ-ACK in multi-cell groups as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting, to a UE, signaling indicating a configuration for communications via the first cell group and a second cell group, the first cell group including the first cell associated with transmission of HARQ-ACK feedback associated with the first cell group and the second cell group including a second cell associated with transmission of HARQ-ACK feedback associated with the second cell group. The communications manager 1120 is capable of, configured to, or operable to support a means for obtaining second information indicative of the HARQ-ACK feedback associated with the second cell group from the UE, where the second information includes a format that is in accordance with a first information that is output to the second cell of the second cell group, the first information including a first payload size that is smaller than a second payload size of the HARQ-ACK feedback associated with the second cell group.

Additionally, or alternatively, the communications manager 1120 may support wireless communications in accordance with examples as disclosed herein. For example, the communications manager 1120 is capable of, configured to, or operable to support a means for obtaining signaling indicating a configuration for communications for a UE via a first cell group and the second cell group, the first cell group including a first cell associated with transmission of HARQ-ACK feedback associated with the first cell group and the second cell group including the second cell associated with transmission of HARQ-ACK feedback associated with the second cell group. The communications manager 1120 is capable of, configured to, or operable to support a means for obtaining first information indicative of the HARQ-ACK feedback associated with the second cell group from the UE, where the first information includes a first payload size that is smaller than a second payload size of the HARQ-ACK feedback associated with the second cell group and second information indicative of the HARQ-ACK feedback associated with the second cell group is output to the first cell, the second information including a format that is in accordance with the first information.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for two-part HARQ-ACK feedback associated with a second cell group where the first part is sent to the second cell of the second cell group and the second part is sent to the first cell of the first cell group. The first part may have a first payload size that is smaller than the full HARQ-ACK feedback payload size and the second part may have a format that is based on the first part. The second cell (e.g., the high-band DU/RU) may reuse some or all of the HARQ process identifiers based on the first part, in some examples, or based on the first and second parts, in other examples.

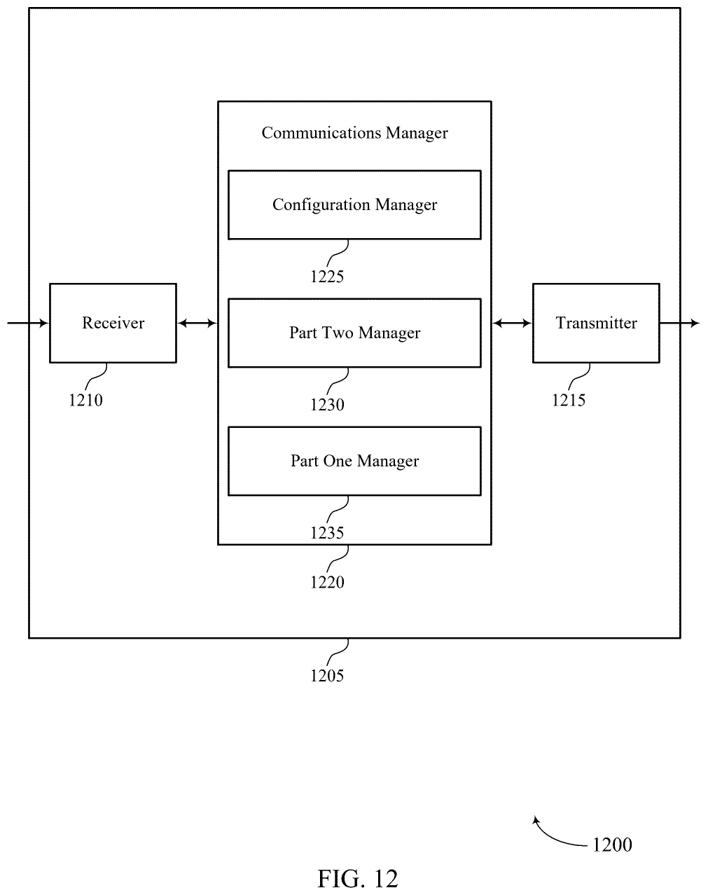

FIG. 12 shows a block diagram 1200 of a device 1205 that supports two-part HARQ-ACK in multi-cell groups in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one of more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of two-part HARQ-ACK in multi-cell groups as described herein. For example, the communications manager 1220 may include a configuration manager 1225, a part two manager 1230, a part one manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The configuration manager 1225 is capable of, configured to, or operable to support a means for outputting, to a UE, signaling indicating a configuration for communications via the first cell group and a second cell group, the first cell group including the first cell associated with transmission of HARQ-ACK feedback associated with the first cell group and the second cell group including a second cell associated with transmission of HARQ-ACK feedback associated with the second cell group. The part two manager 1230 is capable of, configured to, or operable to support a means for obtaining second information indicative of the HARQ-ACK feedback associated with the second cell group from the UE, where the second information includes a format that is in accordance with a first information that is output to the second cell of the second cell group, the first information including a first payload size that is smaller than a second payload size of the HARQ-ACK feedback associated with the second cell group.

Additionally, or alternatively, the communications manager 1220 may support wireless communications in accordance with examples as disclosed herein. The configuration manager 1225 is capable of, configured to, or operable to support a means for obtaining signaling indicating a configuration for communications for a UE via a first cell group and the second cell group, the first cell group including a first cell associated with transmission of HARQ-ACK feedback associated with the first cell group and the second cell group including the second cell associated with transmission of HARQ-ACK feedback associated with the second cell group. The part one manager 1235 is capable of, configured to, or operable to support a means for obtaining first information indicative of the HARQ-ACK feedback associated with the second cell group from the UE, where the first information includes a first payload size that is smaller than a second payload size of the HARQ-ACK feedback associated with the second cell group and second information indicative of the HARQ-ACK feedback associated with the second cell group is output to the first cell, the second information including a format that is in accordance with the first information.

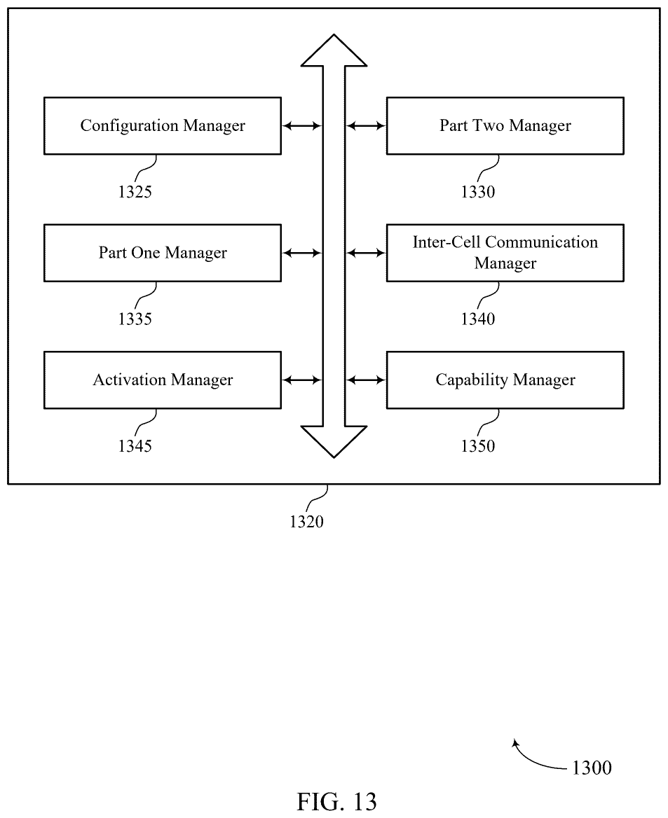

FIG. 13 shows a block diagram 1300 of a communications manager 1320 that supports two-part HARQ-ACK in multi-cell groups in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of two-part HARQ-ACK in multi-cell groups as described herein. For example, the communications manager 1320 may include a configuration manager 1325, a part two manager 1330, a part one manager 1335, an inter-cell communication manager 1340, an activation manager 1345, a capability manager 1350, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The configuration manager 1325 is capable of, configured to, or operable to support a means for outputting, to a UE, signaling indicating a configuration for communications via the first cell group and a second cell group, the first cell group including the first cell associated with transmission of HARQ-ACK feedback associated with the first cell group and the second cell group including a second cell associated with transmission of HARQ-ACK feedback associated with the second cell group. The part two manager 1330 is capable of, configured to, or operable to support a means for obtaining second information indicative of the HARQ-ACK feedback associated with the second cell group from the UE, where the second information includes a format that is in accordance with a first information that is output to the second cell of the second cell group, the first information including a first payload size that is smaller than a second payload size of the HARQ-ACK feedback associated with the second cell group.

In some examples, the inter-cell communication manager 1340 is capable of, configured to, or operable to support a means for decoding the second information to identify at least a portion of the HARQ-ACK feedback associated with the second cell group. In some examples, the inter-cell communication manager 1340 is capable of, configured to, or operable to support a means for outputting the at least the portion of the HARQ-ACK feedback to the second cell of the second cell group.

In some examples, the inter-cell communication manager 1340 is capable of, configured to, or operable to support a means for obtaining at least a portion of the first information from the second cell in the second cell group. In some examples, the inter-cell communication manager 1340 is capable of, configured to, or operable to support a means for decoding the second information in accordance with the at least the portion of the first information to identify the HARQ-ACK feedback associated with the second cell group. In some examples, the inter-cell communication manager 1340 is capable of, configured to, or operable to support a means for outputting the HARQ-ACK feedback to the second cell of the second cell group.

In some examples, the first information includes bundled information in accordance with a logical operation applied to a set of bits in the HARQ-ACK feedback associated with the second cell group. In some examples, the bundled information includes a single bit indicating whether each bit in the set of bits are associated with an ACK indication. In some examples, the first information includes bundled information in accordance with a logical operation applied to a set of bits in each block of a set of blocks in the HARQ-ACK feedback associated with the second cell group. In some examples, the bundled information includes a single bit for each block in the set of blocks indicating whether each bit in the set of bits for that block are associated with an ACK indication. In some examples, the first information includes an indication of at least one of the HARQ-ACK feedback when the HARQ-ACK feedback is in a first bit value set or an indication that the HARQ-ACK feedback is not in the first bit value set.

In some examples, the first bit value set corresponds to a set of outcomes for the HARQ-ACK feedback that satisfies a likelihood threshold. In some examples, the first bit value set corresponds to HARQ-ACK feedback including a threshold number of NACK indications. In some examples, the first information includes an indication of at least one of, for each block in a set of blocks in the HARQ-ACK feedback associated with the second cell group, the HARQ-ACK feedback when the HARQ-ACK feedback for the block is in a first bit value set or an indication that the HARQ-ACK feedback for the block is not in the first bit value set. In some examples, the first bit value set for each block in the set of blocks corresponds to a set of outcomes for the HARQ-ACK feedback that satisfies a likelihood threshold. In some examples, the first bit value set corresponds to, for each block in the set of blocks, HARQ-ACK feedback for the block including a threshold number of NACK indications.

In some examples, the first information includes a first set of one or more bits that identify a group index for a set of groups. In some examples, the first set of one or more bits include a fixed quantity of bits and each bit combination in the first set of one or more bits corresponds to a different group in the set of groups. In some examples, the second information includes a second set of one or more bits that identify a group member of a group in the set of groups in accordance with the group index. In some examples, the second set of one or more bits include a variable quantity of bits and a bit size of a bit combination in the second set of one or more bits is in accordance with a quantity of members in the group in accordance with the group index identified by the first information.

In some examples, the second information includes the HARQ-ACK feedback associated with the second cell group. In some examples, the second information includes an indication of whether the first information indicates the HARQ-ACK feedback associated with the second cell group. In some examples, the second information includes an indication of whether the HARQ-ACK feedback is in a first bit value set or is in a second bit value set and, when the HARQ-ACK feedback is in the second bit value set, the HARQ-ACK feedback. In some examples, the second bit value set includes either a full set of bit values excluded from the first bit value set or a subset of bit values excluded from the first bit value set.

In some examples, the activation manager 1345 is capable of, configured to, or operable to support a means for outputting, to the UE, RRC signaling that activates the UE to transmit the first information to the second cell and to transmit the second information to the first cell.

In some examples, the capability manager 1350 is capable of, configured to, or operable to support a means for obtaining, from the UE, UE capability signaling that indicates the UE supports transmitting the first information to the second cell and transmitting the second information to the first cell, where the configuration is in accordance with the UE capability signaling.

Additionally, or alternatively, the communications manager 1320 may support wireless communications in accordance with examples as disclosed herein. In some examples, the configuration manager 1325 is capable of, configured to, or operable to support a means for obtaining signaling indicating a configuration for communications for a UE via a first cell group and the second cell group, the first cell group including a first cell associated with transmission of HARQ-ACK feedback associated with the first cell group and the second cell group including the second cell associated with transmission of HARQ-ACK feedback associated with the second cell group. The part one manager 1335 is capable of, configured to, or operable to support a means for obtaining first information indicative of the HARQ-ACK feedback associated with the second cell group from the UE, where the first information includes a first payload size that is smaller than a second payload size of the HARQ-ACK feedback associated with the second cell group and second information indicative of the HARQ-ACK feedback associated with the second cell group is output to the first cell, the second information including a format that is in accordance with the first information.

In some examples, the inter-cell communication manager 1340 is capable of, configured to, or operable to support a means for outputting at least a portion of the first information to the second cell of the second cell group. In some examples, the inter-cell communication manager 1340 is capable of, configured to, or operable to support a means for obtaining at least a portion of the second information from the second cell in the second cell group in accordance with the first information. In some examples, the inter-cell communication manager 1340 is capable of, configured to, or operable to support a means for decoding the first information and the second information in accordance with the at least the portion of the second information to identify the HARQ-ACK feedback associated with the second cell group.

In some examples, the first information includes bundled information in accordance with a logical operation applied to a set of bits in the HARQ-ACK feedback associated with the second cell group. In some examples, the bundled information includes a single bit indicating whether each bit in the set of bits are associated with an ACK indication. In some examples, the first information includes bundled information in accordance with a logical operation applied to a set of bits in each block of a set of blocks in the HARQ-ACK feedback associated with the second cell group. In some examples, the bundled information includes a single bit for each block in the set of blocks indicating whether each bit in the set of bits for that block are associated with an ACK indication.

In some examples, the first information includes an indication of at least one of the HARQ-ACK feedback when the HARQ-ACK feedback is in a first bit value set or an indication that the HARQ-ACK feedback is not in the first bit value set. In some examples, the first bit value set corresponds to HARQ-ACK feedback including a threshold number of NACK indications. In some examples, the first bit value set corresponds to a set of outcomes for the HARQ-ACK feedback that satisfies a likelihood threshold. In some examples, the first information includes an indication of at least one of, for each block in a set of blocks in the HARQ-ACK feedback associated with the second cell group, the HARQ-ACK feedback when the HARQ-ACK feedback for the block is in a first bit value set or an indication that the HARQ-ACK feedback for the block is not in the first bit value set.

In some examples, the first bit value set for each block in the set of blocks corresponds to a set of outcomes for the HARQ-ACK feedback that satisfies a likelihood threshold. In some examples, the first bit value set corresponds to, for each block in the set of blocks, HARQ-ACK feedback for the block including a threshold number of NACK indications. In some examples, the first information includes a first set of one or more bits that identify a group index for a set of groups. In some examples, the first set of one or more bits include a fixed quantity of bits and each bit combination in the first set of one or more bits corresponds to a different group in a set of groups. In some examples, the second information includes a second set of one or more bits that identify a group member of a group in the set of groups in accordance with the group index. In some examples, the second set of one or more bits include a variable quantity of bits and a bit size of a bit combination in the second set of one or more bits is in accordance with a quantity of members in the group in accordance with the group index identified by the first information.

In some examples, the second information includes the HARQ-ACK feedback associated with the second cell group. In some examples, the second information includes an indication of whether the first information indicates the HARQ-ACK feedback associated with the second cell group. In some examples, the second information includes an indication of whether the HARQ-ACK feedback is in a first bit value set or is in a second bit value set and, when the HARQ-ACK feedback is in the second bit value set, the HARQ-ACK feedback. In some examples, the second bit value set includes either a full set of bit values excluded from the first bit value set or a subset of bit values excluded from the first bit value set.

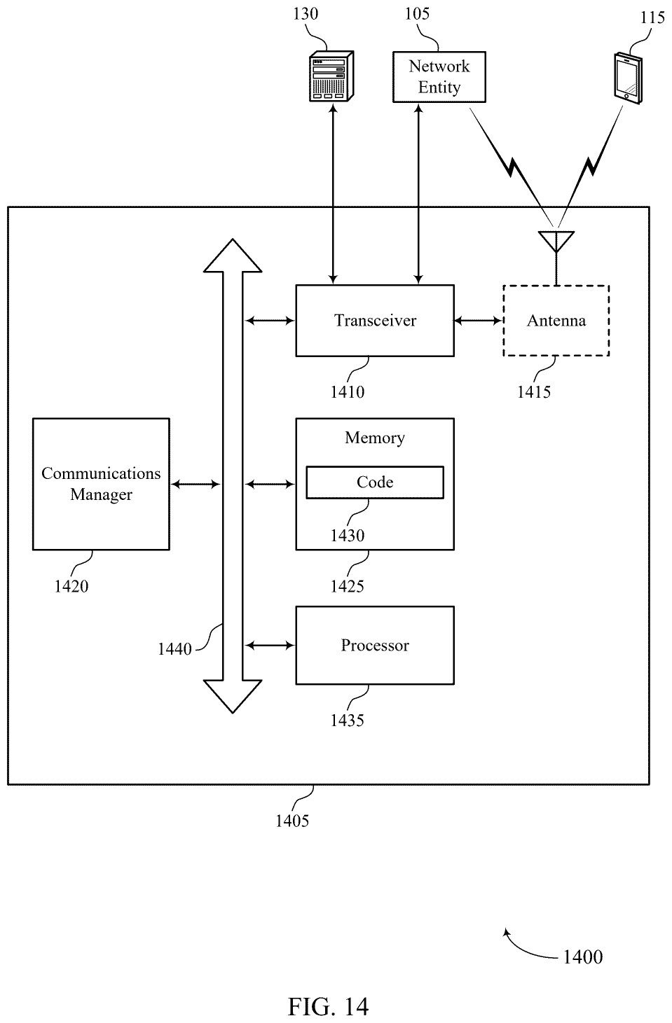

FIG. 14 shows a diagram of a system 1400 including a device 1405 that supports two-part HARQ-ACK in multi-cell groups in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting two-part HARQ-ACK in multi-cell groups). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for outputting, to a UE, signaling indicating a configuration for communications via the first cell group and a second cell group, the first cell group including the first cell associated with transmission of HARQ-ACK feedback associated with the first cell group and the second cell group including a second cell associated with transmission of HARQ-ACK feedback associated with the second cell group. The communications manager 1420 is capable of, configured to, or operable to support a means for obtaining second information indicative of the HARQ-ACK feedback associated with the second cell group from the UE, where the second information includes a format that is in accordance with a first information that is output to the second cell of the second cell group, the first information including a first payload size that is smaller than a second payload size of the HARQ-ACK feedback associated with the second cell group.

Additionally, or alternatively, the communications manager 1420 may support wireless communications in accordance with examples as disclosed herein. For example, the communications manager 1420 is capable of, configured to, or operable to support a means for obtaining signaling indicating a configuration for communications for a UE via a first cell group and the second cell group, the first cell group including a first cell associated with transmission of HARQ-ACK feedback associated with the first cell group and the second cell group including the second cell associated with transmission of HARQ-ACK feedback associated with the second cell group. The communications manager 1420 is capable of, configured to, or operable to support a means for obtaining first information indicative of the HARQ-ACK feedback associated with the second cell group from the UE, where the first information includes a first payload size that is smaller than a second payload size of the HARQ-ACK feedback associated with the second cell group and second information indicative of the HARQ-ACK feedback associated with the second cell group is output to the first cell, the second information including a format that is in accordance with the first information.

By including or configuring the communications manager 1420 in accordance with examples as described herein, the device 1405 may support techniques for two-part HARQ-ACK feedback associated with a second cell group where the first part is sent to the second cell of the second cell group and the second part is sent to the first cell of the first cell group. The first part may have a first payload size that is smaller than the full HARQ-ACK feedback payload size and the second part may have a format that is based on the first part. The second cell (e.g., the high-band DU/RU) may reuse some or all of the HARQ process identifiers based on the first part, in some examples, or based on the first and second parts, in other examples.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of two-part HARQ-ACK in multi-cell groups as described herein, or the at least one processor 1435 and the at least one memory 1425 may be otherwise configured to, individually or collectively, perform or support such operations.

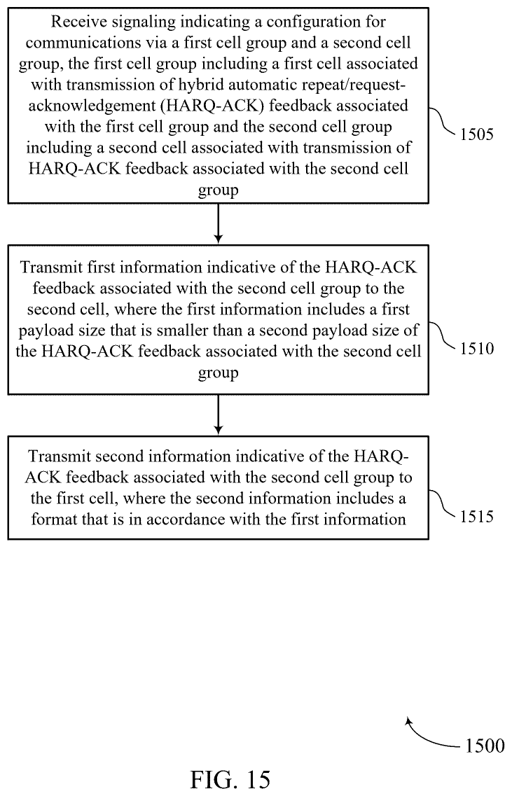

FIG. 15 shows a flowchart illustrating a method 1500 that supports two-part HARQ-ACK in multi-cell groups in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving signaling indicating a configuration for communications via a first cell group and a second cell group, the first cell group including a first cell associated with transmission of HARQ-ACK feedback associated with the first cell group and the second cell group including a second cell associated with transmission of HARQ-ACK feedback associated with the second cell group. The operations of 1505 may be performed in accordance with examples as disclosed herein. In some examples, aspects of the operations of 1505 may be performed by a configuration manager 925 as described with reference to FIG. 9.

At 1510, the method may include transmitting first information indicative of the HARQ-ACK feedback associated with the second cell group to the second cell, where the first information includes a first payload size that is smaller than a second payload size of the HARQ-ACK feedback associated with the second cell group. The operations of 1510 may be performed in accordance with examples as disclosed herein. In some examples, aspects of the operations of 1510 may be performed by a part one manager 930 as described with reference to FIG. 9.

At 1515, the method may include transmitting second information indicative of the HARQ-ACK feedback associated with the second cell group to the first cell, where the second information includes a format that is in accordance with the first information. The operations of 1515 may be performed in accordance with examples as disclosed herein. In some examples, aspects of the operations of 1515 may be performed by a part two manager 935 as described with reference to FIG. 9.

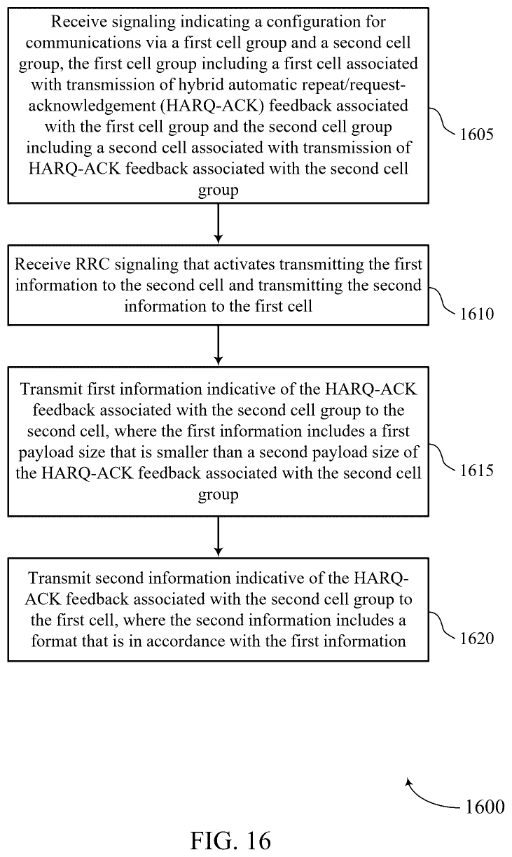

FIG. 16 shows a flowchart illustrating a method 1600 that supports two-part HARQ-ACK in multi-cell groups in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving signaling indicating a configuration for communications via a first cell group and a second cell group, the first cell group including a first cell associated with transmission of HARQ-ACK feedback associated with the first cell group and the second cell group including a second cell associated with transmission of HARQ-ACK feedback associated with the second cell group. The operations of 1605 may be performed in accordance with examples as disclosed herein. In some examples, aspects of the operations of 1605 may be performed by a configuration manager 925 as described with reference to FIG. 9.

At 1610, the method may include receiving RRC signaling that activates transmitting the first information to the second cell and transmitting the second information to the first cell. The operations of 1610 may be performed in accordance with examples as disclosed herein. In some examples, aspects of the operations of 1610 may be performed by an activation manager 940 as described with reference to FIG. 9.

At 1615, the method may include transmitting first information indicative of the HARQ-ACK feedback associated with the second cell group to the second cell, where the first information includes a first payload size that is smaller than a second payload size of the HARQ-ACK feedback associated with the second cell group. The operations of 1615 may be performed in accordance with examples as disclosed herein. In some examples, aspects of the operations of 1615 may be performed by a part one manager 930 as described with reference to FIG. 9.

At 1620, the method may include transmitting second information indicative of the HARQ-ACK feedback associated with the second cell group to the first cell, where the second information includes a format that is in accordance with the first information. The operations of 1620 may be performed in accordance with examples as disclosed herein. In some examples, aspects of the operations of 1620 may be performed by a part two manager 935 as described with reference to FIG. 9.

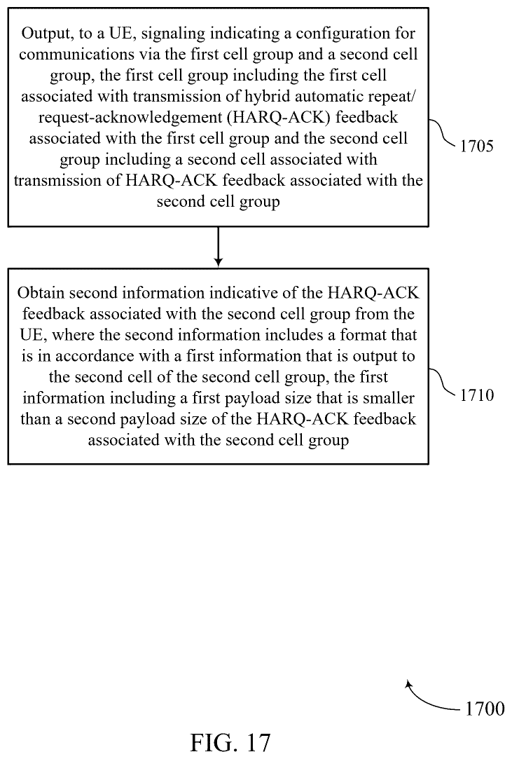

FIG. 17 shows a flowchart illustrating a method 1700 that supports two-part HARQ-ACK in multi-cell groups in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include outputting, to a UE, signaling indicating a configuration for communications via the first cell group and a second cell group, the first cell group including the first cell associated with transmission of HARQ-ACK feedback associated with the first cell group and the second cell group including a second cell associated with transmission of HARQ-ACK feedback associated with the second cell group. The operations of 1705 may be performed in accordance with examples as disclosed herein. In some examples, aspects of the operations of 1705 may be performed by a configuration manager 1325 as described with reference to FIG. 13.

At 1710, the method may include obtaining second information indicative of the HARQ-ACK feedback associated with the second cell group from the UE, where the second information includes a format that is in accordance with a first information that is output to the second cell of the second cell group, the first information including a first payload size that is smaller than a second payload size of the HARQ-ACK feedback associated with the second cell group. The operations of 1710 may be performed in accordance with examples as disclosed herein. In some examples, aspects of the operations of 1710 may be performed by a part two manager 1330 as described with reference to FIG. 13.

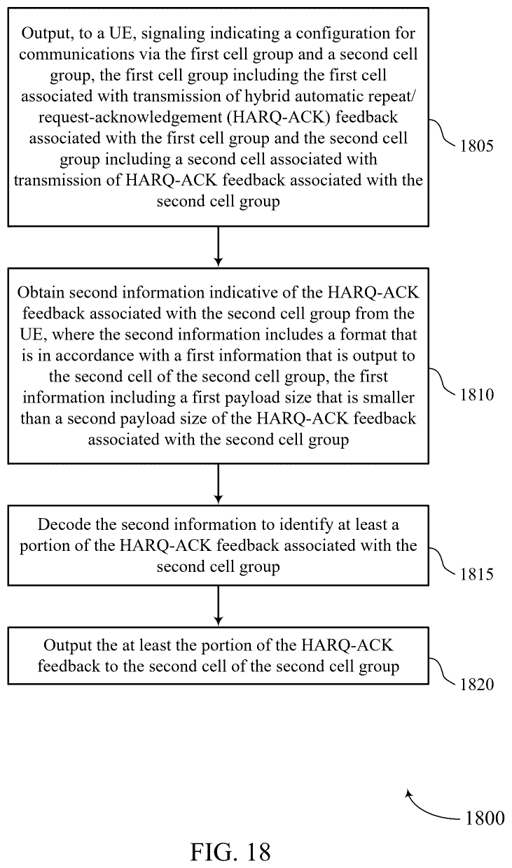

FIG. 18 shows a flowchart illustrating a method 1800 that supports two-part HARQ-ACK in multi-cell groups in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include outputting, to a UE, signaling indicating a configuration for communications via the first cell group and a second cell group, the first cell group including the first cell associated with transmission of HARQ-ACK feedback associated with the first cell group and the second cell group including a second cell associated with transmission of HARQ-ACK feedback associated with the second cell group. The operations of 1805 may be performed in accordance with examples as disclosed herein. In some examples, aspects of the operations of 1805 may be performed by a configuration manager 1325 as described with reference to FIG. 13.

At 1810, the method may include obtaining second information indicative of the HARQ-ACK feedback associated with the second cell group from the UE, where the second information includes a format that is in accordance with a first information that is output to the second cell of the second cell group, the first information including a first payload size that is smaller than a second payload size of the HARQ-ACK feedback associated with the second cell group. The operations of 1810 may be performed in accordance with examples as disclosed herein. In some examples, aspects of the operations of 1810 may be performed by a part two manager 1330 as described with reference to FIG. 13.

At 1815, the method may include decoding the second information to identify at least a portion of the HARQ-ACK feedback associated with the second cell group. The operations of 1815 may be performed in accordance with examples as disclosed herein. In some examples, aspects of the operations of 1815 may be performed by an inter-cell communication manager 1340 as described with reference to FIG. 13.

At 1820, the method may include outputting the at least the portion of the HARQ-ACK feedback to the second cell of the second cell group. The operations of 1820 may be performed in accordance with examples as disclosed herein. In some examples, aspects of the operations of 1820 may be performed by an inter-cell communication manager 1340 as described with reference to FIG. 13.

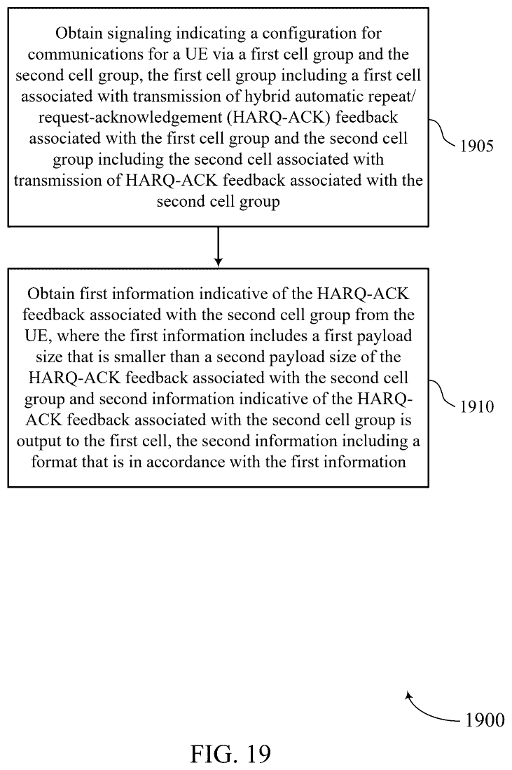

FIG. 19 shows a flowchart illustrating a method 1900 that supports two-part HARQ-ACK in multi-cell groups in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include obtaining signaling indicating a configuration for communications for a UE via a first cell group and the second cell group, the first cell group including a first cell associated with transmission of HARQ-ACK feedback associated with the first cell group and the second cell group including the second cell associated with transmission of HARQ-ACK feedback associated with the second cell group. The operations of 1905 may be performed in accordance with examples as disclosed herein. In some examples, aspects of the operations of 1905 may be performed by a configuration manager 1325 as described with reference to FIG. 13.

At 1910, the method may include obtaining first information indicative of the HARQ-ACK feedback associated with the second cell group from the UE, where the first information includes a first payload size that is smaller than a second payload size of the HARQ-ACK feedback associated with the second cell group and second information indicative of the HARQ-ACK feedback associated with the second cell group is output to the first cell, the second information including a format that is in accordance with the first information. The operations of 1910 may be performed in accordance with examples as disclosed herein. In some examples, aspects of the operations of 1910 may be performed by a part one manager 1335 as described with reference to FIG. 13.

The following provides an overview of aspects of the present disclosure:
Aspect 1: A method for wireless communications at a UE, comprising: receiving signaling indicating a configuration for communications via a first cell group and a second cell group, the first cell group comprising a first cell associated with transmission of HARQ-ACK feedback associated with the first cell group and the second cell group comprising a second cell associated with transmission of HARQ-ACK feedback associated with the second cell group; transmitting first information indicative of the HARQ-ACK feedback associated with the second cell group to the second cell, wherein the first information comprises a first payload size that is smaller than a second payload size of the HARQ-ACK feedback associated with the second cell group; and transmitting second information indicative of the HARQ-ACK feedback associated with the second cell group to the first cell, wherein the second information comprises a format that is in accordance with the first information.
Aspect 2: The method of aspect 1, wherein the first information comprises bundled information in accordance with a logical operation applied to a set of bits in the HARQ-ACK feedback associated with the second cell group.
Aspect 3: The method of aspect 2, wherein the bundled information comprises a single bit indicating whether each bit in the set of bits are associated with an ACK indication.
Aspect 4: The method of any of aspects 1 through 3, wherein the first information comprises bundled information in accordance with a logical operation applied to a set of bits in each block of a set of blocks in the HARQ-ACK feedback associated with the second cell group.
Aspect 5: The method of aspect 4, wherein the bundled information comprises a single bit for each block in the set of blocks indicating whether each bit in the set of bits for that block are associated with an ACK indication.
Aspect 6: The method of any of aspects 1 through 5, wherein the first information comprises an indication of at least one of the HARQ-ACK feedback when the HARQ-ACK feedback is in a first bit value set or an indication that the HARQ-ACK feedback is not in the first bit value set.
Aspect 7: The method of aspect 6, wherein the first bit value set corresponds to a set of outcomes for the HARQ-ACK feedback that satisfies a likelihood threshold.
Aspect 8: The method of any of aspects 6 through 7, wherein the first bit value set corresponds to HARQ-ACK feedback comprising a threshold number of NACK indications.
Aspect 9: The method of any of aspects 1 through 8, wherein the first information comprises an indication of at least one of, for each block in a set of blocks in the HARQ-ACK feedback associated with the second cell group, the HARQ-ACK feedback when the HARQ-ACK feedback for the block is in a first bit value set or an indication that the HARQ-ACK feedback for the block is not in the first bit value set.
Aspect 10: The method of aspect 9, wherein the first bit value set for each block in the set of blocks corresponds to a set of outcomes for the HARQ-ACK feedback that satisfies a likelihood threshold.
Aspect 11: The method of any of aspects 9 through 10, wherein the first bit value set corresponds to, for each block in the set of blocks, HARQ-ACK feedback for the block comprising a threshold number of negative-acknowledgement (NACK) indications.
Aspect 12: The method of any of aspects 1 through 11, wherein the first information comprises a first set of one or more bits that identify a group index for a set of groups.
Aspect 13: The method of aspect 12, wherein the first set of one or more bits comprise a fixed quantity of bits and each bit combination in the first set of one or more bits corresponds to a different group in the set of groups.
Aspect 14: The method of any of aspects 12 through 13, wherein the second information comprises a second set of one or more bits that identify a group member of a group in the set of groups in accordance with the group index.
Aspect 15: The method of aspect 14, wherein the second set of one or more bits comprise a variable quantity of bits and a bit size of a bit combination in the second set of one or more bits is in accordance with a quantity of members in the group in accordance with the group index identified by the first information.
Aspect 16: The method of any of aspects 1 through 15, wherein the second information comprises the HARQ-ACK feedback associated with the second cell group.
Aspect 17: The method of any of aspects 1 through 16, wherein the second information comprises an indication of whether the first information indicates the HARQ-ACK feedback associated with the second cell group.
Aspect 18: The method of any of aspects 1 through 17, wherein the second information comprises an indication of whether the HARQ-ACK feedback is in a first bit value set or is in a second bit value set and, when the HARQ-ACK feedback is in the second bit value set, the HARQ-ACK feedback.
Aspect 19: The method of aspect 18, wherein the second bit value set comprises either a full set of bit values excluded from the first bit value set or a subset of bit values excluded from the first bit value set.
Aspect 20: The method of any of aspects 1 through 19, further comprising: receiving RRC signaling that activates transmitting the first information to the second cell and transmitting the second information to the first cell.
Aspect 21: The method of any of aspects 1 through 20, further comprising: transmitting UE capability signaling indicating support for transmitting the first information to the second cell and transmitting the second information to the first cell, wherein the configuration is in accordance with the UE capability signaling.
Aspect 22: A method for wireless communications at a first cell of a first cell group, comprising: outputting, to a UE, signaling indicating a configuration for communications via the first cell group and a second cell group, the first cell group comprising the first cell associated with transmission of HARQ-ACK feedback associated with the first cell group and the second cell group comprising a second cell associated with transmission of HARQ-ACK feedback associated with the second cell group; and obtaining second information indicative of the HARQ-ACK feedback associated with the second cell group from the UE, wherein the second information comprises a format that is in accordance with a first information that is output to the second cell of the second cell group, the first information comprising a first payload size that is smaller than a second payload size of the HARQ-ACK feedback associated with the second cell group.
Aspect 23: The method of aspect 22, further comprising: decoding the second information to identify at least a portion of the HARQ-ACK feedback associated with the second cell group; and outputting the at least the portion of the HARQ-ACK feedback to the second cell of the second cell group.
Aspect 24: The method of any of aspects 22 through 23, further comprising: obtaining at least a portion of the first information from the second cell in the second cell group; decoding the second information in accordance with the at least the portion of the first information to identify the HARQ-ACK feedback associated with the second cell group; and outputting the HARQ-ACK feedback to the second cell of the second cell group.
Aspect 25: The method of any of aspects 22 through 24, wherein the first information comprises bundled information in accordance with a logical operation applied to a set of bits in the HARQ-ACK feedback associated with the second cell group.
Aspect 26: The method of aspect 25, wherein the bundled information comprises a single bit indicating whether each bit in the set of bits are associated with an ACK indication.
Aspect 27: The method of any of aspects 22 through 26, wherein the first information comprises bundled information in accordance with a logical operation applied to a set of bits in each block of a set of blocks in the HARQ-ACK feedback associated with the second cell group.
Aspect 28: The method of aspect 27, wherein the bundled information comprises a single bit for each block in the set of blocks indicating whether each bit in the set of bits for that block are associated with an ACK indication.
Aspect 29: The method of any of aspects 22 through 28, wherein the first information comprises an indication of at least one of the HARQ-ACK feedback when the HARQ-ACK feedback is in a first bit value set or an indication that the HARQ-ACK feedback is not in the first bit value set.
Aspect 30: The method of aspect 29, wherein the first bit value set corresponds to a set of outcomes for the HARQ-ACK feedback that satisfies a likelihood threshold.
Aspect 31: The method of any of aspects 29 through 30, wherein the first bit value set corresponds to HARQ-ACK feedback comprising a threshold number of NACK indications.
Aspect 32: The method of any of aspects 22 through 31, wherein the first information comprises an indication of at least one of, for each block in a set of blocks in the HARQ-ACK feedback associated with the second cell group, the HARQ-ACK feedback when the HARQ-ACK feedback for the block is in a first bit value set or an indication that the HARQ-ACK feedback for the block is not in the first bit value set.
Aspect 33: The method of aspect 32, wherein the first bit value set for each block in the set of blocks corresponds to a set of outcomes for the HARQ-ACK feedback that satisfies a likelihood threshold.
Aspect 34: The method of any of aspects 32 through 33, wherein the first bit value set corresponds to, for each block in the set of blocks, HARQ-ACK feedback for the block comprising a threshold number of NACK indications.
Aspect 35: The method of any of aspects 22 through 34, wherein the first information comprises a first set of one or more bits that identify a group index for a set of groups.
Aspect 36: The method of aspect 35, wherein the first set of one or more bits comprise a fixed quantity of bits and each bit combination in the first set of one or more bits corresponds to a different group in the set of groups.
Aspect 37: The method of any of aspects 35 through 36, wherein the second information comprises a second set of one or more bits that identify a group member of a group in the set of groups in accordance with the group index.
Aspect 38: The method of aspect 37, wherein the second set of one or more bits comprise a variable quantity of bits and a bit size of a bit combination in the second set of one or more bits is in accordance with a quantity of members in the group in accordance with the group index identified by the first information.
Aspect 39: The method of any of aspects 22 through 38, wherein the second information comprises the HARQ-ACK feedback associated with the second cell group.
Aspect 40: The method of any of aspects 22 through 39, wherein the second information comprises an indication of whether the first information indicates the HARQ-ACK feedback associated with the second cell group.
Aspect 41: The method of any of aspects 22 through 40, wherein the second information comprises an indication of whether the HARQ-ACK feedback is in a first bit value set or is in a second bit value set and, when the HARQ-ACK feedback is in the second bit value set, the HARQ-ACK feedback.
Aspect 42: The method of aspect 41, wherein the second bit value set comprises either a full set of bit values excluded from the first bit value set or a subset of bit values excluded from the first bit value set.
Aspect 43: The method of any of aspects 22 through 42, further comprising: outputting, to the UE, RRC signaling that activates the UE to transmit the first information to the second cell and to transmit the second information to the first cell.
Aspect 44: The method of any of aspects 22 through 43, further comprising: obtaining, from the UE, UE capability signaling that indicates the UE supports transmitting the first information to the second cell and transmitting the second information to the first cell, wherein the configuration is in accordance with the UE capability signaling.
Aspect 45: A method for wireless communications at a second cell of a second cell group, comprising: obtaining signaling indicating a configuration for communications for a UE via a first cell group and the second cell group, the first cell group comprising a first cell associated with transmission of HARQ-ACK feedback associated with the first cell group and the second cell group comprising the second cell associated with transmission of HARQ-ACK feedback associated with the second cell group; and obtaining first information indicative of the HARQ-ACK feedback associated with the second cell group from the UE, wherein the first information comprises a first payload size that is smaller than a second payload size of the HARQ-ACK feedback associated with the second cell group and second information indicative of the HARQ-ACK feedback associated with the second cell group is output to the first cell, the second information comprising a format that is in accordance with the first information.
Aspect 46: The method of aspect 45, further comprising: outputting at least a portion of the first information to the second cell of the second cell group; obtaining at least a portion of the second information from the second cell in the second cell group in accordance with the first information; and decoding the first information and the second information in accordance with the at least the portion of the second information to identify the HARQ-ACK feedback associated with the second cell group.
Aspect 47: The method of any of aspects 45 through 46, wherein the first information comprises bundled information in accordance with a logical operation applied to a set of bits in the HARQ-ACK feedback associated with the second cell group.
Aspect 48: The method of aspect 47, wherein the bundled information comprises a single bit indicating whether each bit in the set of bits are associated with an ACK indication.
Aspect 49: The method of any of aspects 45 through 48, wherein the first information comprises bundled information in accordance with a logical operation applied to a set of bits in each block of a set of blocks in the HARQ-ACK feedback associated with the second cell group.
Aspect 50: The method of aspect 49, wherein the bundled information comprises a single bit for each block in the set of blocks indicating whether each bit in the set of bits for that block are associated with an ACK indication.
Aspect 51: The method of any of aspects 45 through 50, wherein the first information comprises an indication of at least one of the HARQ-ACK feedback when the HARQ-ACK feedback is in a first bit value set or an indication that the HARQ-ACK feedback is not in the first bit value set.
Aspect 52: The method of aspect 51, wherein the first bit value set corresponds to HARQ-ACK feedback comprising a threshold number of NACK indications.
Aspect 53: The method of any of aspects 45 through 52, wherein the first bit value set corresponds to a set of outcomes for the HARQ-ACK feedback that satisfies a likelihood threshold.
Aspect 54: The method of any of aspects 45 through 53, wherein the first information comprises an indication of at least one of, for each block in a set of blocks in the HARQ-ACK feedback associated with the second cell group, the HARQ-ACK feedback when the HARQ-ACK feedback for the block is in a first bit value set or an indication that the HARQ-ACK feedback for the block is not in the first bit value set.
Aspect 55: The method of aspect 54, wherein the first bit value set for each block in the set of blocks corresponds to a set of outcomes for the HARQ-ACK feedback that satisfies a likelihood threshold.
Aspect 56: The method of any of aspects 54 through 55, wherein the first bit value set corresponds to, for each block in the set of blocks, HARQ-ACK feedback for the block comprising a threshold number of NACK indications.
Aspect 57: The method of any of aspects 45 through 56, wherein the first information comprises a first set of one or more bits that identify a group index for a set of groups.
Aspect 58: The method of aspect 57, wherein the first set of one or more bits comprise a fixed quantity of bits and each bit combination in the first set of one or more bits corresponds to a different group in a set of groups.
Aspect 59: The method of any of aspects 57 through 58, wherein the second information comprises a second set of one or more bits that identify a group member of a group in the set of groups in accordance with the group index.
Aspect 60: The method of aspect 59, wherein the second set of one or more bits comprise a variable quantity of bits and a bit size of a bit combination in the second set of one or more bits is in accordance with a quantity of members in the group in accordance with the group index identified by the first information.
Aspect 61: The method of any of aspects 45 through 60, wherein the second information comprises the HARQ-ACK feedback associated with the second cell group.
Aspect 62: The method of any of aspects 45 through 61, wherein the second information comprises an indication of whether the first information indicates the HARQ-ACK feedback associated with the second cell group.
Aspect 63: The method of any of aspects 45 through 62, wherein the second information comprises an indication of whether the HARQ-ACK feedback is in a first bit value set or is in a second bit value set and, when the HARQ-ACK feedback is in the second bit value set, the HARQ-ACK feedback.
Aspect 64: The method of aspect 63, wherein the second bit value set comprises either a full set of bit values excluded from the first bit value set or a subset of bit values excluded from the first bit value set.
Aspect 65: A UE for wireless communications, comprising one or more memories storing processor-executable code, and one or more processors coupled with the one or more memories and individually or collectively operable to execute the code to cause the UE to perform a method of any of aspects 1 through 21.
Aspect 66: A UE for wireless communications, comprising at least one means for performing a method of any of aspects 1 through 21.
Aspect 67: A non-transitory computer-readable medium storing code for wireless communications, the code comprising instructions executable by one or more processors to perform a method of any of aspects 1 through 21.
Aspect 68: A wireless device associated with a first cell of a first cell group for wireless communications, comprising one or more memories storing processor-executable code, and one or more processors coupled with the one or more memories and individually or collectively operable to execute the code to cause the first cell of a first cell group to perform a method of any of aspects 22 through 44.
Aspect 69: A first cell of a first cell group for wireless communications, comprising at least one means for performing a method of any of aspects 22 through 44.
Aspect 70: A non-transitory computer-readable medium storing code for wireless communications, the code comprising instructions executable by one or more processors to perform a method of any of aspects 22 through 44.
Aspect 71: A wireless device associated with a second cell of a second cell group for wireless communications, comprising one or more memories storing processor-executable code, and one or more processors coupled with the one or more memories and individually or collectively operable to execute the code to cause the second cell of a second cell group to perform a method of any of aspects 45 through 64.
Aspect 72: A second cell of a second cell group for wireless communications, comprising at least one means for performing a method of any of aspects 45 through 64.
Aspect 73: A non-transitory computer-readable medium storing code for wireless communications, the code comprising instructions executable by one or more processors to perform a method of any of aspects 45 through 64.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.” Similarly, references to a “set” may include one or more members in the set.

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive signaling indicating a configuration for communications via a first cell group and a second cell group, the first cell group comprising a first cell associated with transmission of hybrid automatic repeat/request-acknowledgement (HARQ-ACK) feedback associated with the first cell group and the second cell group comprising a second cell associated with transmission of HARQ-ACK feedback associated with the second cell group;
transmit first information indicative of the HARQ-ACK feedback associated with the second cell group to the second cell, wherein the first information comprises a first payload size that is smaller than a second payload size of the HARQ-ACK feedback associated with the second cell group; and
transmit second information indicative of the HARQ-ACK feedback associated with the second cell group to the first cell, wherein the second information comprises a format that is in accordance with the first information.

2. The UE of claim 1, wherein the first information comprises bundled information in accordance with a logical operation applied to a set of bits in the HARQ-ACK feedback associated with the second cell group.

3. The UE of claim 2, wherein the bundled information comprises a single bit indicating whether each bit in the set of bits are associated with an ACK indication.

4. The UE of claim 1, wherein the first information comprises bundled information in accordance with a logical operation applied to a set of bits in each block of a set of blocks in the HARQ-ACK feedback associated with the second cell group.

5. The UE of claim 4, wherein the bundled information comprises a single bit for each block in the set of blocks indicating whether each bit in the set of bits for that block are associated with an ACK indication.

6. The UE of claim 1, wherein the first information comprises an indication of at least one of the HARQ-ACK feedback when the HARQ-ACK feedback is in a first bit value set or an indication that the HARQ-ACK feedback is not in the first bit value set.

7. The UE of claim 6, wherein the first bit value set corresponds to a set of outcomes for the HARQ-ACK feedback that satisfies a likelihood threshold.

8. The UE of claim 6, wherein the first bit value set corresponds to HARQ-ACK feedback comprising a threshold number of negative-acknowledgement (NACK) indications.

9. The UE of claim 1, wherein the first information comprises an indication of at least one of, for each block in a set of blocks in the HARQ-ACK feedback associated with the second cell group, the HARQ-ACK feedback when the HARQ-ACK feedback for the block is in a first bit value set or an indication that the HARQ-ACK feedback for the block is not in the first bit value set.

10. The UE of claim 9, wherein the first bit value set for each block in the set of blocks corresponds to a set of outcomes for the HARQ-ACK feedback that satisfies a likelihood threshold.

11. The UE of claim 9, wherein the first bit value set corresponds to, for each block in the set of blocks, HARQ-ACK feedback for the block comprising a threshold number of negative-acknowledgement (NACK) indications.

12. The UE of claim 1, wherein the first information comprises a first set of one or more bits that identify a group index for a set of groups.

13. The UE of claim 12, wherein the first set of one or more bits comprise a fixed quantity of bits and each bit combination in the first set of one or more bits corresponds to a different group in the set of groups.

14. The UE of claim 12, wherein the second information comprises a second set of one or more bits that identify a group member of a group in the set of groups in accordance with the group index.

15. The UE of claim 14, wherein the second set of one or more bits comprise a variable quantity of bits and a bit size of a bit combination in the second set of one or more bits is in accordance with a quantity of members in the group in accordance with the group index identified by the first information.

16. The UE of claim 1, wherein the second information comprises the HARQ-ACK feedback associated with the second cell group.

17. The UE of claim 1, wherein the second information comprises an indication of whether the first information indicates the HARQ-ACK feedback associated with the second cell group.

18. The UE of claim 1, wherein the second information comprises an indication of whether the HARQ-ACK feedback is in a first bit value set or is in a second bit value set and, when the HARQ-ACK feedback is in the second bit value set, the HARQ-ACK feedback.

19. The UE of claim 18, wherein the second bit value set comprises either a full set of bit values excluded from the first bit value set or a subset of bit values excluded from the first bit value set.

20. The UE of claim 1, wherein the one or more processors are individually or collectively further operable to execute the code to cause the UE to:
receive radio resource control (RRC) signaling that activates transmitting the first information to the second cell and transmitting the second information to the first cell.

21. The UE of claim 1, wherein the one or more processors are individually or collectively further operable to execute the code to cause the UE to:
transmit UE capability signaling indicating support for transmitting the first information to the second cell and transmitting the second information to the first cell, wherein the configuration is in accordance with the UE capability signaling.

22. A wireless device associated with a first cell of a first cell group, comprising:
one or more memories storing processor-executable code; and
one or more processors coupled with the one or more memories and individually or collectively operable to execute the code to cause the first cell of a first cell group to:
output, to a user equipment (UE), signaling indicating a configuration for communications via the first cell group and a second cell group, the first cell group comprising the first cell associated with transmission of hybrid automatic repeat/request-acknowledgement (HARQ-ACK) feedback associated with the first cell group and the second cell group comprising a second cell associated with transmission of HARQ-ACK feedback associated with the second cell group; and
obtain second information indicative of the HARQ-ACK feedback associated with the second cell group from the UE, wherein the second information comprises a format that is in accordance with a first information that is output to the second cell of the second cell group, the first information comprising a first payload size that is smaller than a second payload size of the HARQ-ACK feedback associated with the second cell group.

23. A method for wireless communications at a user equipment (UE), comprising:
receiving signaling indicating a configuration for communications via a first cell group and a second cell group, the first cell group comprising a first cell associated with transmission of hybrid automatic repeat/request-acknowledgement (HARQ-ACK) feedback associated with the first cell group and the second cell group comprising a second cell associated with transmission of HARQ-ACK feedback associated with the second cell group;
transmitting first information indicative of the HARQ-ACK feedback associated with the second cell group to the second cell, wherein the first information comprises a first payload size that is smaller than a second payload size of the HARQ-ACK feedback associated with the second cell group; and
transmitting second information indicative of the HARQ-ACK feedback associated with the second cell group to the first cell, wherein the second information comprises a format that is in accordance with the first information.

24. The method of claim 23, wherein the first information comprises bundled information in accordance with a logical operation applied to a set of bits in the HARQ-ACK feedback associated with the second cell group.

25. The method of claim 24, wherein the bundled information comprises a single bit indicating whether each bit in the set of bits are associated with an ACK indication.

26. The method of claim 23, wherein the first information comprises bundled information in accordance with a logical operation applied to a set of bits in each block of a set of blocks in the HARQ-ACK feedback associated with the second cell group.

27. The method of claim 26, wherein the bundled information comprises a single bit for each block in the set of blocks indicating whether each bit in the set of bits for that block are associated with an ACK indication.

28. The method of claim 23, wherein the first information comprises an indication of at least one of the HARQ-ACK feedback when the HARQ-ACK feedback is in a first bit value set or an indication that the HARQ-ACK feedback is not in the first bit value set.

29. The method of claim 28, wherein the first bit value set corresponds to a set of outcomes for the HARQ-ACK feedback that satisfies a likelihood threshold.

30. A method for wireless communications at a first cell of a first cell group, comprising:
outputting, to a user equipment (UE), signaling indicating a configuration for communications via the first cell group and a second cell group, the first cell group comprising the first cell associated with transmission of hybrid automatic repeat/request-acknowledgement (HARQ-ACK) feedback associated with the first cell group and the second cell group comprising a second cell associated with transmission of HARQ-ACK feedback associated with the second cell group; and
obtaining second information indicative of the HARQ-ACK feedback associated with the second cell group from the UE, wherein the second information comprises a format that is in accordance with a first information that is output to the second cell of the second cell group, the first information comprising a first payload size that is smaller than a second payload size of the HARQ-ACK feedback associated with the second cell group.
